(19) United States
(12) Patent Application Publication
(10) Pub. No.: US 2015/0139310 A1
(43) Pub. Date: May 21, 2015

(54) IMAGE PROCESSING APPARATUS AND IMAGE PROCESSING METHOD

(71) Applicant: SONY CORPORATION, Tokyo (JP)

(72) Inventors: Shuo Lu, Tokyo (JP); Teruhiko Suzuki, Kanagawa (JP)

(73) Assignee: SONY CORPORATION, Tokyo (JP)

(21) Appl. No.: 14/402,238

(22) PCT Filed: Jun. 21, 2013
(86) PCT No.: PCT/JP2013/067113

§ 371 Date: Nov. 19, 2014

(30) Foreign Application Priority Data
Jun. 29, 2012 (JP) 2012-147884

(51) Int. Cl. H04N 19/573; H04N 19/597; H04N 19/30

(52) U.S. Cl. CPC H04N 19/573; H04N 19/30; H04N 19/597
USPC 375/240.12

(57) ABSTRACT

The present technique relates to an image processing apparatus and an image processing method capable of suppressing deterioration in accuracy of a predicted image and reducing the number of storable reference images. A motion prediction/compensation unit generates a predicted image of an encoding target image by using a reference image. A frame memory is, for example, a decoded picture buffer (DPB) and preferentially stores the reference image of which display order is close to that of the encoding target image. The present technique may be applied to, for example, an encoding device using a high efficiency video coding (HEVC) scheme.

### TECHNICAL FIELD

The present technique relates to an image processing apparatus and an image processing method and, more particularly, to an image processing apparatus and an image processing method capable of suppressing deterioration in accuracy of a predicted image and reducing the number of storable reference images.

### BACKGROUND ART

In recent years, apparatuses according to moving picture experts group phase (MPEG) schemes or the like in which image information is treated as digital data and, at this time, for the purpose of high-efficiency information transmission and accumulation, compression is performed through orthogonal transform such as discrete cosine transform and motion compensation by using redundancy unique to the image information have been widely used for information distribution of broadcasting stations or the like and for information reception at ordinary homes.

Particularly, the MPEG-2 (ISO/IEC 13818-2) scheme is defined as a general-purpose image encoding scheme, and as a standard covering both of interlaced scanning images and sequential scanning images and covering standard resolution images and high-accuracy images, the MPEG-2 scheme is widely used for a wide range of applications of professional uses and consumer uses. By using the MPEG-2 scheme, for example, a bit rate of 4 to 8 Mbps is allocated to an interlaced scanning image having a standard resolution of 720×480 pixels, and a bit rate of 18 to 22 Mbps is allocated to an interlaced scanning image having a high resolution of 1920×1088 pixels, so that a high compression rate and a good image quality may be implemented.

The MPEG-2 is mainly applied to high image quality encoding which is suitable for broadcasting, but it does not correspond to an encoding scheme having a bit rate lower than that of the MPEG-1, that is, an encoding scheme having a higher compression rate. With the spread of mobile phones, needs for the encoding scheme are expected to be increased, and accordingly, the MPEG-4 encoding scheme is standardized.

With respect to the image encoding scheme of the MPEG-4, the ISO/IEC 14496-2 standard was approved as an international standard in December, 1998.

In addition, in recent years, for the purpose of image encoding for TV conference, standardization called H.26L (ITU-T Q6/16 VCEG) has been promoted. It is known that, in comparison with the encoding schemes such as the MPEG-2 or the MPEG-4 in the related art, in the H.26L, although a large calculation amount is needed for encoding and decoding, a higher encoding efficiency is implemented.

In addition, at present, as a part of activities of the MPEG-4, standardization which is based on the H.26L and incorporates functions which are not supported in the H.26L to implement a higher encoding efficiency is performed as Joint Model of Enhanced-Compression Video Coding. The standard was approved as an international standard on the basis named H.264 and MPEG-4 Part 10 (AVC (Advanced Video Coding)) in March, 2003.

In addition, as extension thereof, standardization of Fidelity Range Extension (FRExt) including RGB, encoding tools necessary for business such as 4:2:2 or 4:4:4, 8×8 DCT defined by the MPEG-2, and quantization matrix was completed in February, 2005. Accordingly, the AVC became an encoding scheme capable of representing film noise included in a movie with a good quality. Therefore, the AVC has been used for a wide range of applications such as Blu-Ray (registered trade mark) disc.

However, recently, needs for high compression rate encoding, for example, a need to compress images of about 4000×2000 pixels which is four times of a high-vision image or a need to distribute a high-vision image in a limited-transmission-rate environment such as the Internet have been further increased. Therefore, in the video coding expert group (VCEG) under the ITU-T, improvement of an encoding efficiency continues to be studied.

Moreover, at present, for the purpose of further improvement of the encoding efficiency in comparison with the H.264/AVC, standardization of an encoding scheme called high efficiency video coding (HEVC) has been promoted by the joint collaboration team-video coding (JCTVC) as a joint standardization body of the ITU-T and the ISO/IEC. With respect to the HEVC standard, Committee Draft as a first draft specification was issued in February, 2012 (for example, refer to Non-Patent Document 1).

### CITATION LIST

### Non-Patent Document

Non-Patent Document 1: Benjamin Bross, Woo-Jin Han, Jens-Rainer Ohm, Gary J. Sullivan, Thomas Wiegand, “High efficiency video coding (HEVC) text specification draft 6”, JCTVC-H1003 ver20, 2012 Feb. 17

### SUMMARY OF THE INVENTION

### Problems to be Solved by the Invention

In the HEVC scheme, there is a desire to further reduce the number of reference images storable in a decoded picture buffer (DPB).

The present technique is to suppress a deterioration in accuracy of a predicted image and to reduce the number of storable reference images.

### Solutions to Problems

An image processing apparatus according to an aspect of the present technique includes: a predicted image generation unit which generates a predicted image of an image by using a reference image; and a storage unit which preferentially stores the reference image of which display order is close to that of the image.

An image processing method according to an aspect of the present technique corresponds to an image processing apparatus according to an aspect of the present technique.

In an aspect of the present technique, a predicted image of an image is generated by using a reference image, and the reference image of which display order is close to that of the image is preferentially stored.

### Effects of the Invention

According to the present technique, it is possible to suppress a deterioration in accuracy of a predicted image, and it is possible to reduce the number of storable reference images.

### BRIEF DESCRIPTION OF DRAWINGS

FIG. 1 is a block diagram illustrating a configuration example of an embodiment of an encoding device employing the present technique.

FIG. 2 is a diagram illustrating a first example of a reference image stored in a frame memory.

FIG. 3 is a diagram illustrating a second example of a reference image stored in a frame memory.

FIG. 4 is a diagram illustrating a third example of a reference image stored in a frame memory.

FIG. 5 is a diagram illustrating a fourth example of a reference image stored in a frame memory.

FIG. 6 is a flowchart illustrating details of an encoding process of the encoding device illustrated in FIG. 3.

FIG. 7 is a flowchart illustrating details of an encoding process of the encoding device illustrated in FIG. 3.

FIG. 8 is a block diagram illustrating a configuration example of an embodiment of a decoding device employing the present technique.

FIG. 9 is a flowchart illustrating details of a decoding process of the decoding device illustrated in FIG. 8.

FIG. 10 is a diagram illustrating an example of a multiple viewpoint image encoding scheme.

FIG. 11 is a diagram illustrating a main configuration example of a multiple viewpoint image encoding device employing the present technique.

FIG. 12 is a diagram illustrating a main configuration example of a multiple viewpoint image decoding device employing the present technique.

FIG. 13 is a diagram illustrating an example of a hierarchical image encoding scheme.

FIG. 14 is a diagram illustrating an example of spatial scalable encoding.

FIG. 15 is a diagram illustrating an example of temporal scalable encoding.

FIG. 16 is a diagram illustrating an example of signal-to-noise ratio scalable encoding.

FIG. 17 is a diagram illustrating a main configuration example of a hierarchical image encoding device employing the present technique.

FIG. 18 is a diagram illustrating a main configuration example of a hierarchical image decoding device employing the present technique.

FIG. 19 is a block diagram illustrating a configuration example of hardware of a computer.

FIG. 20 is a diagram illustrating a schematic configuration example of a television apparatus employing the present technique.

FIG. 21 is a diagram illustrating a schematic configuration example of a mobile phone employing the present technique.

FIG. 22 is a diagram illustrating a schematic configuration example of a recording/reproducing apparatus employing the present technique.

FIG. 23 is a diagram illustrating a schematic configuration example of an imaging apparatus employing the present technique.

FIG. 24 is a block diagram illustrating an example of use of scalable encoding.

FIG. 25 is a block diagram illustrating another example of use of scalable encoding.

FIG. 26 is a block diagram illustrating still another example of use of scalable encoding.

### MODE FOR CARRYING OUT THE INVENTION

### Embodiment

### Configuration Example of Embodiment of Encoding Device

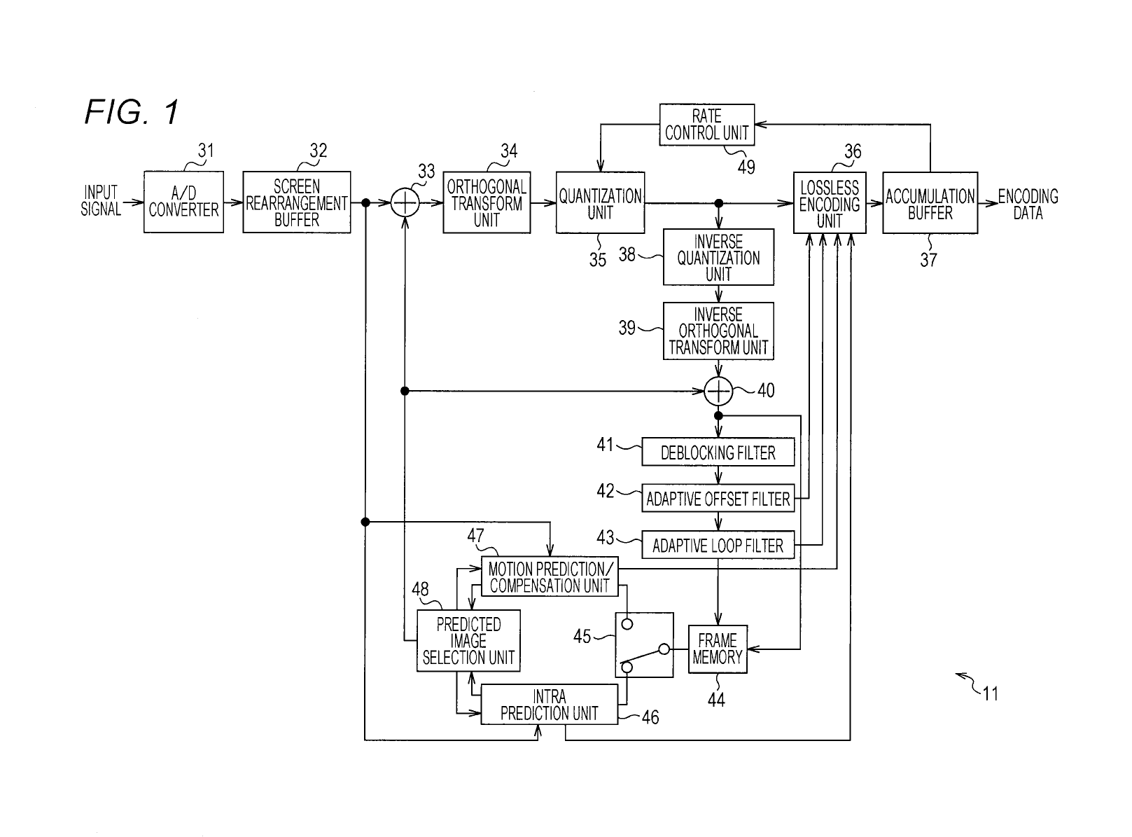

FIG. 1 is a block diagram illustrating a configuration example of an embodiment of an encoding device employing the present technique.

The encoding device 11 illustrated in FIG. 1 is configured to include an A/D converter 31, a screen rearrangement buffer 32, an arithmetic unit 33, an orthogonal transform unit 34, a quantization unit 35, a lossless encoding unit 36, an accumulation buffer 37, an inverse quantization unit 38, an inverse orthogonal transform unit 39, an addition unit 40, a deblocking filter 41, an adaptive offset filter 42, an adaptive loop filter 43, a frame memory 44, a switch 45, an intra prediction unit 46, a motion prediction/compensation unit 47, a predicted image selection unit 48, and a rate control unit 49.

More specifically, the A/D converter 31 of the encoding device 11 A/D-converts frame-unit images input as input signals and outputs the A/D-converted images to the screen rearrangement buffer 32 to store the A/D-converted images. The screen rearrangement buffer 32 rearranges the frame-unit images, which are stored in the display order, in the order for encoding according to a GOP structure and outputs the rearranged images to the arithmetic unit 33, the intra prediction unit 46, and the motion prediction/compensation unit 47.

The arithmetic unit 33 performs encoding by calculating a difference between a predicted image supplied from the predicted image selection unit 48 and an encoding target image output from the screen rearrangement buffer 32. More specifically, the arithmetic unit 33 performs encoding by subtracting the predicted image supplied from the predicted image selection unit 48 from the encoding target image output from the screen rearrangement buffer 32. The arithmetic unit 33 outputs the image obtained as a result thereof as residual information to the orthogonal transform unit 34. In addition, in the case where the predicted image is not supplied from the predicted image selection unit 48, the arithmetic unit 33 outputs the image read out from the screen rearrangement buffer 32 without change as the residual information to the orthogonal transform unit 34.

The orthogonal transform unit 34 performs orthogonal transform on the residual information from the arithmetic unit 33 to generate an orthogonal transform coefficient. The orthogonal transform unit 34 supplies the generated orthogonal transform coefficient to the quantization unit 35.

The quantization unit 35 performs quantization on the orthogonal transform coefficient supplied from the orthogonal transform unit 34 by using quantization parameters supplied from the rate control unit 49. The quantization unit 35 inputs the coefficient obtained as a result thereof to the lossless encoding unit 36.

The lossless encoding unit 36 acquires information (hereinafter, referred to as intra prediction mode information) representing an optimal intra prediction mode from the intra prediction unit 46. In addition, the lossless encoding unit 36 acquires information (hereinafter, referred to as inter prediction mode information) representing an optimal inter prediction mode, motion vectors, and the like from the motion prediction/compensation unit 47. In addition, the lossless encoding unit 36 acquires the quantization parameters from the rate control unit 49.

In addition, the lossless encoding unit 36 acquires a storage flag, an index or an offset, and type information as offset filter information from the adaptive offset filter 42 and acquires a filter coefficient from the adaptive loop filter 43.

The lossless encoding unit 36 performs lossless encoding such as variable length encoding (for example, context-adaptive variable length coding (CAVLC) or the like) and arithmetic encoding (for example, context-adaptive binary arithmetic coding (CABAC) or the like) on the quantized coefficient supplied from the quantization unit 35.

In addition, the lossless encoding unit 36 performs lossless encoding on intra prediction mode information or inter prediction mode information, motion vectors, information for identifying a reference image or the like, quantization parameters, offset filter information, and a filter coefficient as encoding information on the encoding. The lossless encoding unit 36 supplies the lossless-encoded encoding information and the lossless-encoded coefficient as the encoding data to the accumulation buffer 37 to accumulate the encoding data. In addition, the lossless-encoded encoding information may be considered to be header information (slice header) of the lossless-encoded coefficient.

The accumulation buffer 37 temporarily stores the encoding data supplied from the lossless encoding unit 36. In addition, the accumulation buffer 37 outputs the stored encoding data.

In addition, the quantized coefficient output from the quantization unit 35 is also input to the inverse quantization unit 38. The inverse quantization unit 38 performs inverse quantization on the coefficient quantized by the quantization unit 35 by using the quantization parameters supplied from the rate control unit 49 and supplies the orthogonal transform coefficient obtained as a result thereof to the inverse orthogonal transform unit 39.

The inverse orthogonal transform unit 39 performs inverse orthogonal transform on the orthogonal transform coefficient supplied from the inverse quantization unit 38. The inverse orthogonal transform unit 39 supplies residual information obtained as a result of the inverse orthogonal transform to the addition unit 40.

The addition unit 40 obtains a locally decoded image by adding the residual information supplied from the inverse orthogonal transform unit 39 and the predicted image supplied from the predicted image selection unit 48. In addition, in the case where the predicted image is not supplied from the predicted image selection unit 48, the addition unit 40 defines the residual information supplied from the inverse orthogonal transform unit 39 as the locally decoded image. The addition unit 40 supplies the locally decoded image to the deblocking filter 41 and supplies the locally decoded image to the frame memory 44 to accumulate the locally decoded image.

The deblocking filter 41 performs an adaptive deblocking filtering process for removing block distortion on the locally decoded image supplied from the addition unit 40 and supplies the image obtained as a result thereof to the adaptive offset filter 42.

The adaptive offset filter 42 performs an adaptive offset filter (SAO: Sample Adaptive Offset) process for mainly removing ringing on the image after the adaptive deblocking filtering process of the deblocking filter 41.

More specifically, the adaptive offset filter 42 determines a type of the adaptive offset filtering processes for each largest coding unit (LCU) that is a maximum unit of encoding and obtains an offset used for the adaptive offset filtering process. The adaptive offset filter 42 performs the determined type of the adaptive offset filtering process on the image after the adaptive deblocking filtering process by using the obtained offset. Next, the adaptive offset filter 42 supplies the image after the adaptive offset filtering process to the adaptive loop filter 43.

In addition, the adaptive offset filter 42 is configured to include a buffer which stores the offset. The adaptive offset filter 42 determines whether or not the offset used for the adaptive deblocking filtering process in each LCU is stored in the buffer in advance.

In the case where it is determined that the offset used for the adaptive deblocking filtering process is stored in the buffer in advance, the adaptive offset filter 42 sets a storage flag indicating that the offset is stored in the buffer to a value (herein, 1) representing that the offset is stored in the buffer.

Next, the adaptive offset filter 42 supplies the storage flag that is set to 1, an index indicating a storage position of the offset in the buffer, and the type information representing the type of the performed adaptive offset filtering process to the lossless encoding unit 36 in each LCU.

On the other hand, in the case where the offsets used for the adaptive deblocking filtering process are not yet stored in the buffer, the adaptive offset filter 42 stores the offsets in the buffer in order. In addition, the adaptive offset filter 42 sets the storage flag to a value (herein, 0) representing that the offset is not stored in the buffer. Next, the adaptive offset filter 42 supplies the storage flag that is set to 0, the offset, and the type information to the lossless encoding unit 36 in each LCU.

The adaptive loop filter 43 performs, for example, an adaptive loop filtering (ALF) process on the image after the adaptive offset filtering process supplied from the adaptive offset filter 42 in each LCU. As the adaptive loop filtering process, for example, a process using two-dimensional Wiener filter is used. In addition, filters other than the Wiener filter may be used.

More specifically, the adaptive loop filter 43 calculates a filter coefficient used for the adaptive loop filtering process in each LCU so that the residual between the original image that is the image output from the screen rearrangement buffer 32 and the image after the adaptive loop filtering process is minimized. Next, the adaptive loop filter 43 performs the adaptive loop filtering process on the image after the adaptive offset filtering process by using the calculated filter coefficient in each LCU.

The adaptive loop filter 43 supplies the image after the adaptive loop filtering process to the frame memory 44. In addition, the adaptive loop filter 43 supplies the filter coefficient to the lossless encoding unit 36.

In addition, herein, the adaptive loop filtering process is performed in each LCU. However, the processing unit of the adaptive loop filtering process is not limited to the LCU. If the processing unit of the adaptive offset filter 42 and the processing unit of the adaptive loop filter 43 are in accordance with each other, these processes may be efficiently performed.

The frame memory 44 is a DPB and accumulates the image supplied from the adaptive loop filter 43 or the image supplied from the addition unit 40 as the decoded image. The decoded image accumulated in the frame memory 44 is output as a reference image to the intra prediction unit 46 or the motion prediction/compensation unit 47 through the switch 45.

The intra prediction unit 46 performs intra prediction processes in all the candidate intra prediction modes by using the reference image read out from the frame memory 44 through the switch 45 to generate a predicted image as an encoding target image.

In addition, the intra prediction unit 46 calculates cost function values (described later in detail) for all the candidate intra prediction modes based on the image read out from the screen rearrangement buffer 32 and the predicted image generated as a result of the intra prediction process. Next, the intra prediction unit 46 determines the intra prediction mode where the cost function value is minimized as an optimal intra prediction mode.

The intra prediction unit 46 supplies the predicted image generated in the optimal intra prediction mode and the corresponding cost function value to the predicted image selection unit 48. In the case where the selection of the predicted image generated in the optimal intra prediction mode is notified from the predicted image selection unit 48, the intra prediction unit 46 supplies the intra prediction mode information to the lossless encoding unit 36.

In addition, the cost function value is also referred to as a rate distortion (RD) cost and is calculated based on any of methods of a high complexity mode or a low complexity mode which is defined by a joint model (JM) that is reference software in the H.264/AVC scheme.

More specifically, in the case where the high complexity mode is employed as the method of calculating the cost function value, the processes including the decoding are performed on all the candidate prediction modes, and the cost function value expressed by the following Formula (1) is calculated for each prediction mode.

Cost(Mode))=D+λ·R (1)

D denotes a difference (distortion) between the original image and the decoded image; R denotes an occurrence bit rate including the coefficient of the orthogonal transform; and λ denotes a Lagrange multiplier given as a function of a quantization parameter QP.

On the other hand, in the case where the low complexity mode is employed as the method of calculating the cost function value, the predicted images are generated and the bit rate of the encoding information is calculated for all the candidate prediction modes, and the cost function expressed by the following Formula (2) is calculated for each prediction mode.

Cost(Mode)=D+QPtoQuant(QP)·Header_Bit (2)

D denotes a difference (distortion) between the original image and the predicted image; Header_Bit denotes the bit rate of the encoding information; and QPtoQuant denotes a function given as a function of the quantization parameter QP.

In the low complexity mode, only the predicted image may be generated with respect to all the prediction modes, and since there is no need to generate the decoded image, a calculation amount may be small.

The motion prediction/compensation unit 47 performs a motion prediction/compensation process in all the candidate inter prediction modes. More specifically, the motion prediction/compensation unit 47 detects motion vectors in all the candidate inter prediction modes based on the image supplied from the screen rearrangement buffer 32 and the reference image read out from the frame memory 44 through the switch 45. Next, the motion prediction/compensation unit 47 functions as a predicted image generation unit to apply a compensation process to the reference image based on the motion vector to generate the predicted image of the encoding target image.

At this time, the motion prediction/compensation unit 47 calculates the cost function values for all the candidate inter prediction modes based on the image supplied from the screen rearrangement buffer 32 and the predicted image and determines the inter prediction mode where the cost function value is minimized as an optimal inter prediction mode. Next, the motion prediction/compensation unit 47 supplies the cost function value in the optimal inter prediction mode and the corresponding predicted image to the predicted image selection unit 48. In addition, in the case where the selection of the predicted image generated in the optimal inter prediction mode is notified from the predicted image selection unit 48, the motion prediction/compensation unit 47 outputs inter prediction mode information, the corresponding motion vectors, information for identifying the reference image, and the like to the lossless encoding unit 36.

The predicted image selection unit 48 determines the mode where the corresponding cost function value is small among the optimal intra prediction mode and the optimal inter prediction mode as an optimal prediction mode based on the cost function values supplied from the intra prediction unit 46 and the motion prediction/compensation unit 47. Next, the predicted image selection unit 48 supplies the predicted image in the optimal prediction mode to the arithmetic unit 33 and the addition unit 40. In addition, the predicted image selection unit 48 notifies the selection of the predicted image in the optimal prediction mode to the intra prediction unit 46 or the motion prediction/compensation unit 47.

The rate control unit 49 determines the quantization parameter used for the quantization unit 35 based on the encoding data accumulated in the accumulation buffer 37 so that overflow or underflow does not occur. The rate control unit 49 supplies the determined quantization parameter to the quantization unit 35, the lossless encoding unit 36, and the inverse quantization unit 38.

(First Example of Reference Image Stored in Frame Memory)

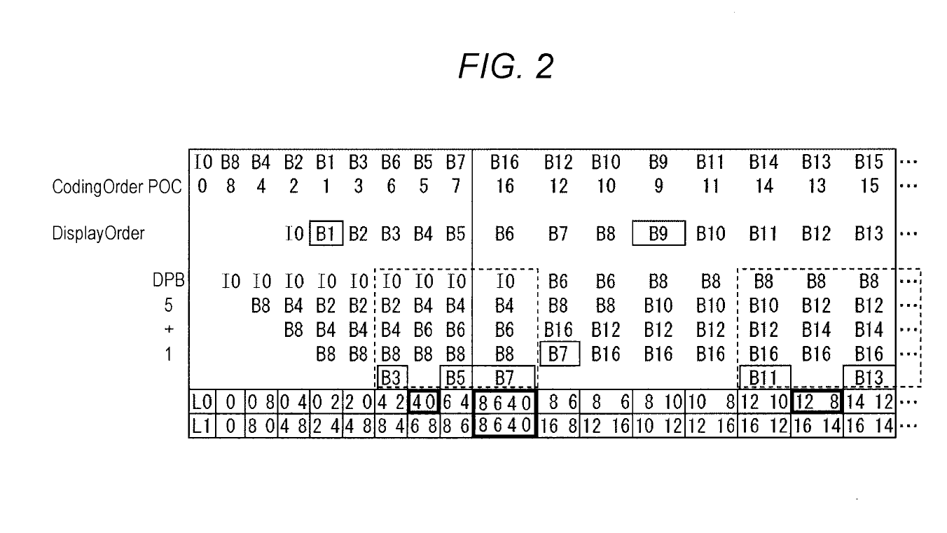

FIG. 2 is a diagram illustrating the reference image stored in the frame memory 44 in the case where the number of reference images storable in the frame memory 44 is 6.

As illustrated in FIG. 2, in the case where the number of reference images storable in the frame memory 44 is 6, the decoded image of one encoding target image and the decoded images of 5 or less encoding-completed images are stored in the frame memory 44. Namely, the frame memory 44 is configured to include a temporary storage area which temporarily stores the decoded image of one encoding target image and a long-term storage area which stores the decoded images of 5 or less encoding-completed images.

In addition, in FIG. 2, I indicates an I picture, and B indicates a B picture. In addition, the numbers following I or B indicate the display orders of the corresponding pictures. In FIG. 2, in the uppermost row, pictures are arranged and written in the encoding order (decoding order). In the second row from the top, the display orders (picture order counts (POCs)) of the pictures in the uppermost row are written. In the third row from the top, pictures displayed at the time of decoding the pictures in the uppermost row are written.

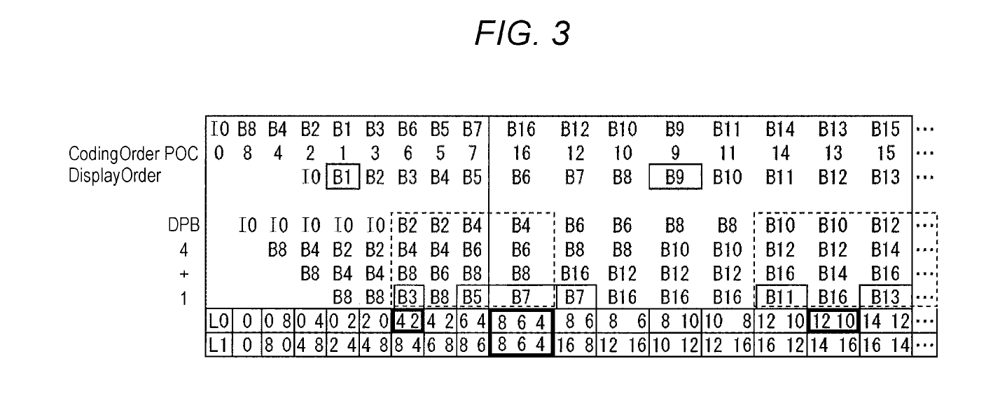

In addition, in the fourth to eighth rows from the top, pictures stored in the long-term storage area of the frame memory 44 at the time of encoding the pictures in the uppermost row are written. In the ninth row from the top, the display orders of the pictures used as the reference images in the L0 prediction at the time of encoding the pictures in the uppermost row are written. In the tenth row from the top, the display orders of the pictures used as the reference images in the L1 prediction at the time of encoding the pictures in the uppermost row are written. These are the same in FIGS. 3 to 5 described later.

As illustrated in FIG. 2, the frame memory 44 stores the pictures of which displaying is not yet completed at the time of decoding the encoding target picture in the long-term storage area. On the other hand, the frame memory 44 does not store the pictures of which displaying is completed at the time of decoding the encoding target picture and which are not used as the reference images in the long-term storage area.

In addition, the frame memory 44 preferentially stores the pictures of which quantization parameter is small rather than the picture of which display order is close to the display order of the encoding target picture in the long-term storage area. For example, at the time of encoding the B picture (B5 picture) of which display order is 5, the frame memory 44 preferentially stores the I picture (I0 picture) of which display order is 0 and of which quantization parameter is small rather than the B picture (B2 picture) of which display order is 2 and is close to the display order of the B5 picture in the long-term storage area.

(Second Example of Reference Image Stored in Frame Memory)

FIG. 3 is a diagram illustrating a first example of the reference image stored in the frame memory 44 in the case where the number of reference images storable in the frame memory 44 is 5.

As illustrated in FIG. 3, in the case where the number of reference images storable in the frame memory 44 is 5, the decoded image of one encoding target image and the decoded images of 4 or less encoding-completed images are stored in the frame memory 44. Namely, the frame memory 44 is configured to include a temporary storage area which temporarily stores the decoded image of one encoding target image and a long-term storage area which stores the decoded images of 4 or less encoding-completed images.

As illustrated in FIG. 3, the frame memory 44 stores the pictures of which displaying is not yet completed at the time of decoding the encoding target picture in the long-term storage area. On the other hand, the frame memory 44 does not store the pictures of which displaying is completed at the time of decoding the encoding target picture and which are not used as the reference images in the long-term storage area.

In addition, the frame memory 44 preferentially stores the pictures of which display orders are close to the display order of the encoding target picture in the long-term storage area. For example, at the time of encoding the B picture (B6 picture) of which display order is 6, the frame memory 44 preferentially stores the B2 picture of which display order is 2 and is close to the display order of the B6 picture rather than the I0 picture of which display order is 0 in the long-term storage area.

(Third Example of Reference Image Stored in Frame Memory)

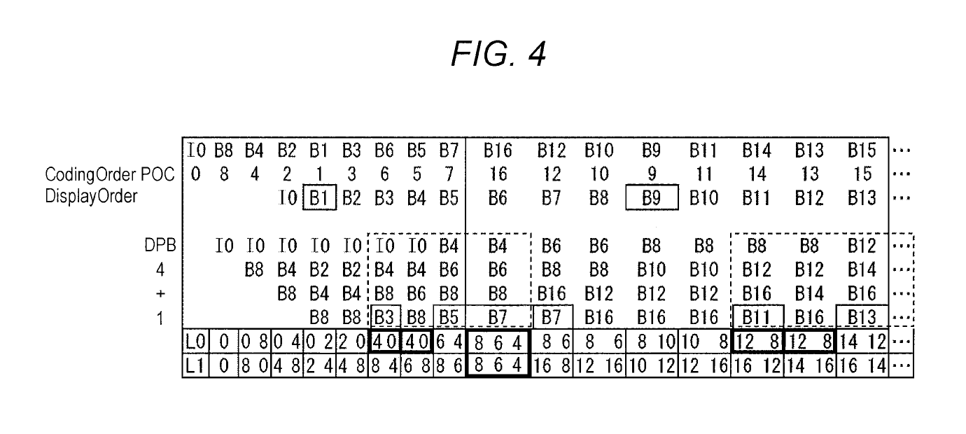

FIG. 4 is a diagram illustrating a second example of the reference image stored in the frame memory 44 in the case where the number of reference images storable in the frame memory 44 is 5.

As described above, in the case where the number of reference images storable in the frame memory 44 is 5, the frame memory 44 is configured to include a temporary storage area which temporarily stores the decoded image of one encoding target image and a long-term storage area which stores the decoded images of 4 or less encoding-completed images.

As illustrated in FIG. 4, the frame memory 44 stores the pictures of which displaying is not yet completed at the time of decoding the encoding target picture in the long-term storage area. On the other hand, the frame memory 44 does not store the pictures of which displaying is completed at the time of decoding the encoding target picture and which are not used as the reference images in the long-term storage area.

In addition, the frame memory 44 partially preferentially stores the pictures of display order is close to the display order of the encoding target picture in the long-term storage area. For example, at the time of encoding the B6 picture of which display order is 6, the frame memory 44 preferentially stores the I0 picture of which display order is 0 and of which quantization parameter is small rather than the B2 picture of which display order is 2 and is close to the display order of the B6 picture in the long-term storage area.

On the other hand, at the time of encoding the B picture (B7 picture) of which display order is 7, the frame memory 44 preferentially stores the B picture (B4 picture) of which display order is 4 and is close to the display order of the B7 picture rather than the I0 picture of which display order is 0 in the long-term storage area.

(Fourth Example of Reference Image Stored in Frame Memory)

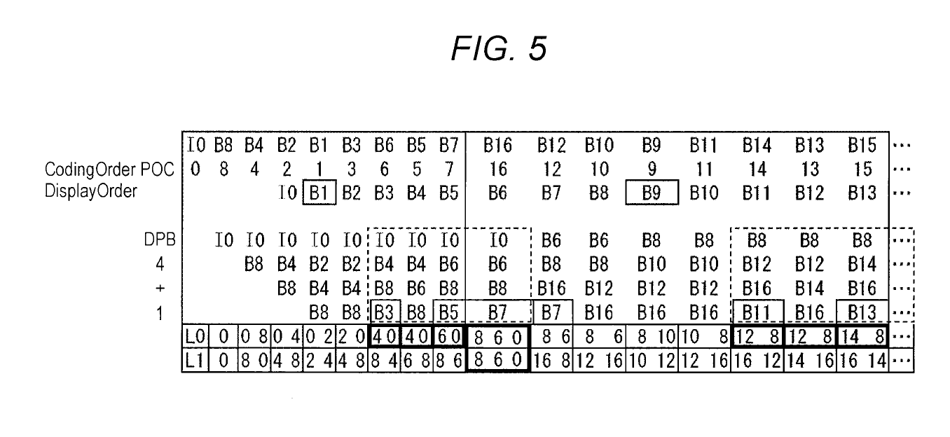

FIG. 5 is a diagram illustrating a third example of the reference image stored in the frame memory 44 in the case where the number of reference images storable in the frame memory 44 is 5.

As described above, in the case where the number of reference images storable in the frame memory 44 is 5, the frame memory 44 is configured to include a temporary storage area which temporarily stores the decoded image of one encoding target image and a long-term storage area which stores the decoded images of 4 or less encoding-completed images.

As illustrated in FIG. 5, the frame memory 44 stores the pictures of which displaying is not yet completed at the time of decoding the encoding target picture in the long-term storage area. On the other hand, the frame memory 44 does not store the pictures of which displaying is completed at the time of decoding the encoding target picture and which are not used as the reference images in the long-term storage area.

In addition, the frame memory 44 preferentially stores the pictures of which quantization parameter is small rather than the picture of which display order is close to the display order of the encoding target picture in the long-term storage area. For example, at the time of encoding the B6 picture of which display order is 6, the frame memory 44 preferentially stores the I0 picture of which display order is 0 and of which quantization parameter is small rather than the B2 picture of which display order is 2 and is close to the display order of the B6 picture in the long-term storage area.

In addition, the number of reference images storable in the frame memory 44 is defined according to the size of the encoding target image, that is, the level of profile, or the like. For example, in the case where the encoding target image is large, the number of reference images storable in the frame memory 44 is set to 5; and in the case where the encoding target image is small, the number of reference images storable in the frame memory 44 is set to 6.

In addition, in the case where the number of reference images storable in the frame memory 44 is 5, the frame memory 44 may stores the reference images according to any of the methods illustrated in FIGS. 3 to 5. In addition, the methods illustrated in FIGS. 3 to 5 may be switched according to the type of the encoding target image or the like. In this case, for example, in the case where the encoding target image is a moving image, the method illustrated in FIG. 3 is used; and in the case where the encoding target image is a still image, the method illustrated in FIG. 5 is used.

(Description of Processes of Encoding Device)

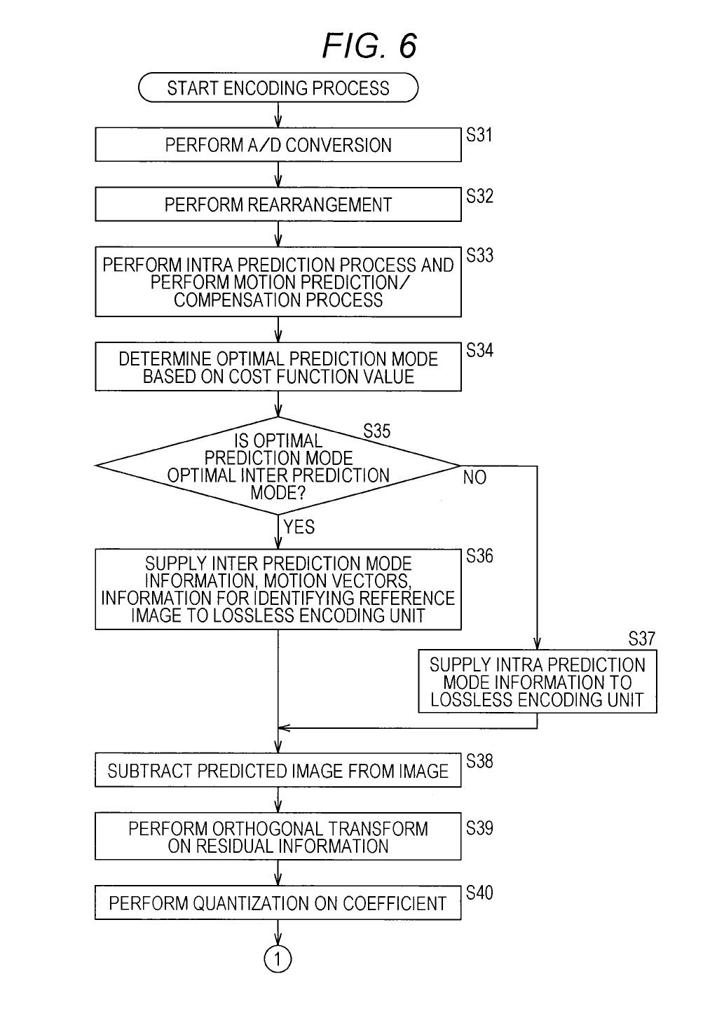

FIG. 6 is a flowchart illustrating details of an encoding process of the encoding device 11 illustrated in FIG. 3.

In step S31 illustrated in FIG. 6, the A/D converter 31 of the encoding device 11 A/D-converts frame-unit images input as input signals and outputs the A/D-converted images to the screen rearrangement buffer 32 to store the A/D-converted images.

In step S32, the screen rearrangement buffer 32 rearranges the frame-unit images, which are stored in the display order, in the order for encoding according to a GOP structure. The screen rearrangement buffer 32 supplies the frame-unit images after the rearrangement to the arithmetic unit 33, the intra prediction unit 46, and the motion prediction/compensation unit 47.

In step S33, the intra prediction unit 46 performs intra prediction processes in all the candidate intra prediction modes. In addition, the intra prediction unit 46 calculates cost function values for all the candidate intra prediction modes based on the image read out from the screen rearrangement buffer 32 and the predicted image generated as a result of the intra prediction process. Next, the intra prediction unit 46 determines the intra prediction mode where the cost function value is minimized as an optimal intra prediction mode. The intra prediction unit 46 supplies the predicted image generated in the optimal intra prediction mode and the corresponding cost function value to the predicted image selection unit 48.

In addition, the motion prediction/compensation unit 47 performs motion prediction/compensation processes in all the candidate inter prediction modes. In addition, the motion prediction/compensation unit 47 calculates cost function values for all the candidate inter prediction modes based on the image supplied from the screen rearrangement buffer 32 and the predicted image and determines the inter prediction mode where the cost function value is minimized as an optimal inter prediction mode. Next, the motion prediction/compensation unit 47 supplies the cost function value in the optimal inter prediction mode and the corresponding predicted image to the predicted image selection unit 48.

In step S34, the predicted image selection unit 48 determines the mode where the cost function value is minimized among the optimal intra prediction mode and the optimal inter prediction mode as an optimal prediction mode based on the cost function values supplied from the intra prediction unit 46 and the motion prediction/compensation unit 47 through the process of step S33. Next, the predicted image selection unit 48 supplies the predicted image in the optimal prediction mode to the arithmetic unit 33 and the addition unit 40.

In step S35, the predicted image selection unit 48 determines whether or not the optimal prediction mode is an optimal inter prediction mode. In the case where it is determined in step S35 that the optimal prediction mode is an optimal inter prediction mode, the predicted image selection unit 48 notifies the selection of the predicted image generated in the optimal inter prediction mode to the motion prediction/compensation unit 47.

Next, in step S36, the motion prediction/compensation unit 47 supplies inter prediction mode information, the corresponding motion vectors, information for identifying the reference image, and the like to the lossless encoding unit 36, and the process proceeds to step S38.

On the other hand, in the case where it is determined in step S35 that the optimal prediction mode is not an optimal inter prediction mode, that is, in the case where the optimal prediction mode is an optimal intra prediction mode, the predicted image selection unit 48 notifies the selection of the predicted image generated in the optimal intra prediction mode to the intra prediction unit 46. Next, in step S37, the intra prediction unit 46 supplies the intra prediction mode information to the lossless encoding unit 36, and the process proceeds to step S38.

In step S38, the arithmetic unit 33 performs encoding by subtracting the predicted image supplied from the predicted image selection unit 48 from the image supplied from the screen rearrangement buffer 32. The arithmetic unit 33 outputs the image obtained as a result thereof as residual information to the orthogonal transform unit 34.

In step S39, the orthogonal transform unit 34 performs orthogonal transform on the residual information from the arithmetic unit 33 and supplies the orthogonal transform coefficient obtained as a result thereof to the quantization unit 35.

In step S40, the quantization unit 35 performs quantization on the coefficient supplied from the orthogonal transform unit 34 by using the quantization parameters supplied from the rate control unit 49. The quantized coefficient is input to the lossless encoding unit 36 and the inverse quantization unit 38.

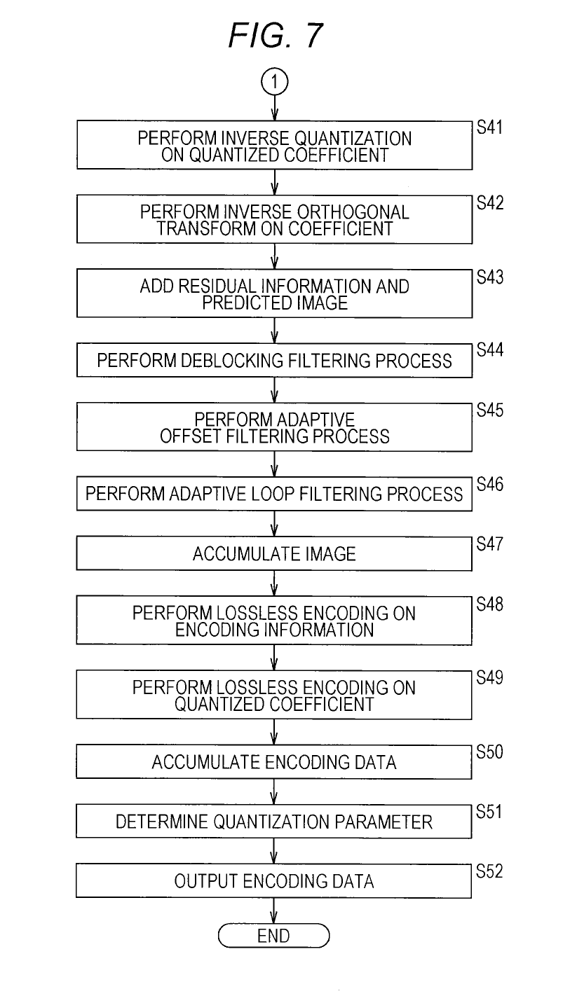

In step S41 illustrated in FIG. 7, the inverse quantization unit 38 performs inverse quantization on the quantized coefficient supplied from the quantization unit 35 by using the quantization parameters supplied from the rate control unit 49 and supplies the orthogonal transform coefficient obtained as a result thereof to the inverse orthogonal transform unit 39.

In step S42, the inverse orthogonal transform unit 39 performs inverse orthogonal transform on the orthogonal transform coefficient supplied from the inverse quantization unit 38 and supplies the residual information obtained as a result thereof to the addition unit 40.

In step S43, the addition unit 40 obtains a locally decoded image by adding the residual information supplied from the inverse orthogonal transform unit 39 and the predicted image supplied from the predicted image selection unit 48. The addition unit 40 supplies the obtained image to the deblocking filter 41 and supplies the obtained image to the frame memory 44.

In step S44, the deblocking filter 41 performs a deblocking filtering process on the locally decoded image supplied from the addition unit 40. The deblocking filter 41 supplies the image obtained as a result thereof to the adaptive offset filter 42.

In step S45, the adaptive offset filter 42 performs an adaptive offset filtering process on the image supplied from the deblocking filter 41 in each LCU. The adaptive offset filter 42 supplies the image obtained as a result thereof to the adaptive loop filter 43. In addition, the adaptive offset filter 42 supplies a storage flag, an index or an offset, and type information as offset filter information to the lossless encoding unit 36 in each LCU.

In step S46, the adaptive loop filter 43 performs an adaptive loop filtering process on the image supplied from the adaptive offset filter 42 in each LCU. The adaptive loop filter 43 supplies the image obtained as a result thereof to the frame memory 44. In addition, the adaptive loop filter 43 supplies a filter coefficient used for the adaptive loop filtering process to the lossless encoding unit 36.

In step S47, as described in FIGS. 2 to 5, the frame memory 44 accumulates the image supplied from the adaptive loop filter 43 or the image supplied from the addition unit 40. The image accumulated in the frame memory 44 is output as a reference image to the intra prediction unit 46 or the motion prediction/compensation unit 47 through the switch 45.

In step S48, the lossless encoding unit 36 performs lossless encoding on intra prediction mode information or inter prediction mode information, motion vectors, information for identifying the reference image or the like, quantization parameters from the rate control unit 49, offset filter information, and a filter coefficient as encoding information.

In step S49, the lossless encoding unit 36 performs lossless encoding on the quantized coefficient supplied from the quantization unit 35. Next, the lossless encoding unit 36 generates encoding data from the lossless-encoded encoding information and the lossless-encoded coefficient which are lossless-encoded in step S48.

In step S50, the accumulation buffer 37 temporarily accumulates the encoding data supplied from the lossless encoding unit 36.

In step S51, the rate control unit 49 determinates the quantization parameter used for the quantization unit 35 based on the encoding data accumulated in the accumulation buffer 37 so that overflow or underflow does not occur. The rate control unit 49 supplies the determined quantization parameter to the quantization unit 35, the lossless encoding unit 36, and the inverse quantization unit 38.

In step S52, the accumulation buffer 37 outputs the stored encoding data.

In addition, in the encoding process illustrated in FIGS. 6 and 7, for simplification of the description, the intra prediction process and the motion prediction/compensation process are always performed. However, in actual cases, only one thereof may be performed according to the type of picture or the like.

As described above, the frame memory 44 of the encoding device 11 performs storing in the manner as described in FIGS. 3 to 5, so that it is possible to reduce the number of storable reference images down to 5. In addition, as described in FIGS. 3 and 4, the frame memory 44 preferentially stores the decoded image of which display order is close to the display order of the encoding target image as the reference image, so that in the case where the encoding target image is a moving image or the like, it is possible to suppress a deterioration in accuracy of the predicted image.

In addition, as described in FIGS. 4 and 5, the frame memory 44 preferentially stores the decoded image of which quantization parameter is small as the reference image, so that in the case where the encoding target image is a still image or the like, it is possible to suppress a deterioration in accuracy of the predicted image.

(Configuration Example of Embodiment of Decoding Device)

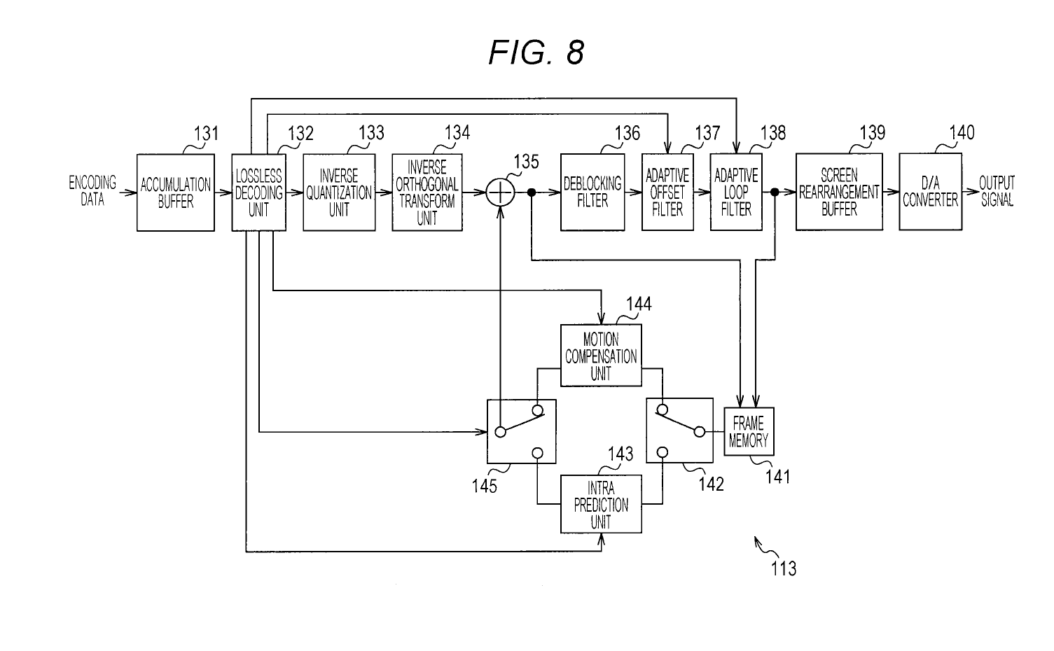

FIG. 8 is a block diagram illustrating a configuration example of an embodiment of a decoding device employing the present technique which decodes an encoding stream transmitted from the encoding device 11 illustrated in FIG. 3.

The decoding device 113 illustrated in FIG. 8 is configured to include an accumulation buffer 131, a lossless decoding unit 132, an inverse quantization unit 133, an inverse orthogonal transform unit 134, an addition unit 135, a deblocking filter 136, an adaptive offset filter 137, an adaptive loop filter 138, a screen rearrangement buffer 139, a D/A converter 140, a frame memory 141, a switch 142, an intra prediction unit 143, a motion compensation unit 144, and a switch 145.

The accumulation buffer 131 of the decoding device 113 receives encoding data transmitted from the encoding device 11 illustrated in FIG. 3 and accumulates the encoding data. The accumulation buffer 131 supplies the accumulated encoding data to the lossless decoding unit 132.

The lossless decoding unit 132 performs lossless decoding such as variable length decoding or arithmetic decoding on the encoding data from the accumulation buffer 131 to obtain a quantized coefficient and encoding information. The lossless decoding unit 132 supplies the quantized coefficient to the inverse quantization unit 133. In addition, the lossless decoding unit 132 supplies intra prediction mode information and the like as the encoding information to the intra prediction unit 143 and supplies motion vectors, inter prediction mode information, information for identifying a reference image, and the like to the motion compensation unit 144.

In addition, the lossless decoding unit 132 supplies the intra prediction mode information or the inter prediction mode information as the encoding information to the switch 145. The lossless decoding unit 132 supplies offset filter information as the encoding information to the adaptive offset filter 137 and supplies a filter coefficient to the adaptive loop filter 138.

The inverse quantization unit 133, the inverse orthogonal transform unit 134, the addition unit 135, the deblocking filter 136, the adaptive offset filter 137, the adaptive loop filter 138, the frame memory 141, the switch 142, the intra prediction unit 143, and the motion compensation unit 144 performs the same processes of those of the inverse quantization unit 38, the inverse orthogonal transform unit 39, the addition unit 40, the deblocking filter 41, the adaptive offset filter 42, the adaptive loop filter 43, the frame memory 44, the switch 45, the intra prediction unit 46, and the motion prediction/compensation unit 47 illustrated in FIG. 4, so that the image is decoded.

More specifically, the inverse quantization unit 133 performs inverse quantization on the quantized coefficient from the lossless decoding unit 132 and supplies an orthogonal transform coefficient obtained as a result thereof to the inverse orthogonal transform unit 134.

The inverse orthogonal transform unit 134 performs inverse orthogonal transform on the orthogonal transform coefficient from the inverse quantization unit 133. The inverse orthogonal transform unit 134 supplies residual information obtained as a result of the inverse orthogonal transform to the addition unit 135.

The addition unit 135 performs decoding by adding the residual information as a decoding target image supplied from the inverse orthogonal transform unit 134 and the predicted image supplied from the switch 145. The addition unit 135 supplies the image obtained as a result of the decoding to the deblocking filter 136 and supplies the image to the frame memory 141. In addition, in the case where the predicted image is not supplied from the switch 145, the addition unit 135 supplies the image that is the residual information supplied from the inverse orthogonal transform unit 134 as the image obtained as a result of the decoding to the deblocking filter 136 and supplies the image to the frame memory 141.

The deblocking filter 136 performs an adaptive deblocking filtering process on the image supplied from the addition unit 135 and supplies the image obtained as a result thereof to the adaptive offset filter 137.

The adaptive offset filter 137 is configured to include a buffer which stores the offsets supplied from the lossless decoding unit 132 in order. In addition, the adaptive offset filter 137 performs an adaptive offset filtering process on the image after the adaptive deblocking filtering process of the deblocking filter 136 based on the offset filter information supplied from the lossless decoding unit 132 in each LCU.

More specifically, in the case where the storage flag included in the offset filter information is 0, the adaptive offset filter 137 performs an adaptive offset filtering process corresponding to the type indicated by the type information on the image after the deblocking filtering process in each LCU by using the offset included in the offset filter information.

On the other hand, in the case where the storage flag included in the offset filter information is 1, the adaptive offset filter 137 reads out the offset stored in the position indicated by the index included in the offset filter information with respect to the image after the deblocking filtering process in each LCU. Next, the adaptive offset filter 137 performs the adaptive offset filtering process corresponding to the type indicated by the type information by using the read-out offset. The adaptive offset filter 137 supplies the image after of the adaptive offset filtering process to the adaptive loop filter 138.

The adaptive loop filter 138 performs the adaptive loop filtering process in each LCU on the image supplied from the adaptive offset filter 137 by using the filter coefficient supplied from the lossless decoding unit 132. The adaptive loop filter 138 supplies the image obtained as a result thereof to the frame memory 141 and the screen rearrangement buffer 139.

The screen rearrangement buffer 139 stores the images supplied from the adaptive loop filter 138 in units of a frame. The screen rearrangement buffer 139 rearranges the frame-unit images, which are stored in the order for encoding, in the original display order and supplies the rearranged images to the D/A converter 140.

The D/A converter 140 D/A-converts the frame-unit image supplied from the screen rearrangement buffer 139 and outputs the D/A-converted images as output signals.

Similarly to the frame memory 44, the frame memory 141 is a DPB and accumulates the image supplied from the adaptive loop filter 138 or the image supplied from the addition unit 135 as the decoded image. More specifically, the information designating the decoded image stored in the frame memory 44 illustrated in FIG. 1, the information designating the methods illustrated in FIGS. 2 to 5, or the like is transmitted from the encoding device 11. Similarly to the frame memory 44, the frame memory 141 controls the storing of the decoded image based on the information transmitted from the encoding device 11. The image accumulated in the frame memory 141 is read out as the reference image and is supplied to the motion compensation unit 144 or the intra prediction unit 143 through the switch 142.

The intra prediction unit 143 performs the intra prediction process in the intra prediction mode indicated by the intra prediction mode information supplied from the lossless decoding unit 132 by using the reference image read out from the frame memory 141 through the switch 142. The intra prediction unit 143 supplies the predicted image of the decoding target image generated as a result thereof to the switch 145.

The motion compensation unit 144 reads out the reference image from the frame memory 141 through the switch 142 based on the information for identifying the reference image supplied from the lossless decoding unit 132. The motion compensation unit 144 functions as a predicted image generation unit to perform a motion compensation process in the optimal inter prediction mode indicated by the inter prediction mode information by using the motion vector and the reference image. The motion compensation unit 144 supplies the predicted image of the decoding target image generated as a result thereof to the switch 145.

In the case where the intra prediction mode information is supplied from the lossless decoding unit 132, the switch 145 supplies the predicted image supplied from the intra prediction unit 143 to the addition unit 135. On the other hand, in the case where the inter prediction mode information is supplied from the lossless decoding unit 132, the switch 145 supplies the predicted image supplied from the motion compensation unit 144 to the addition unit 135.

(Description of Processes of Decoding Device)

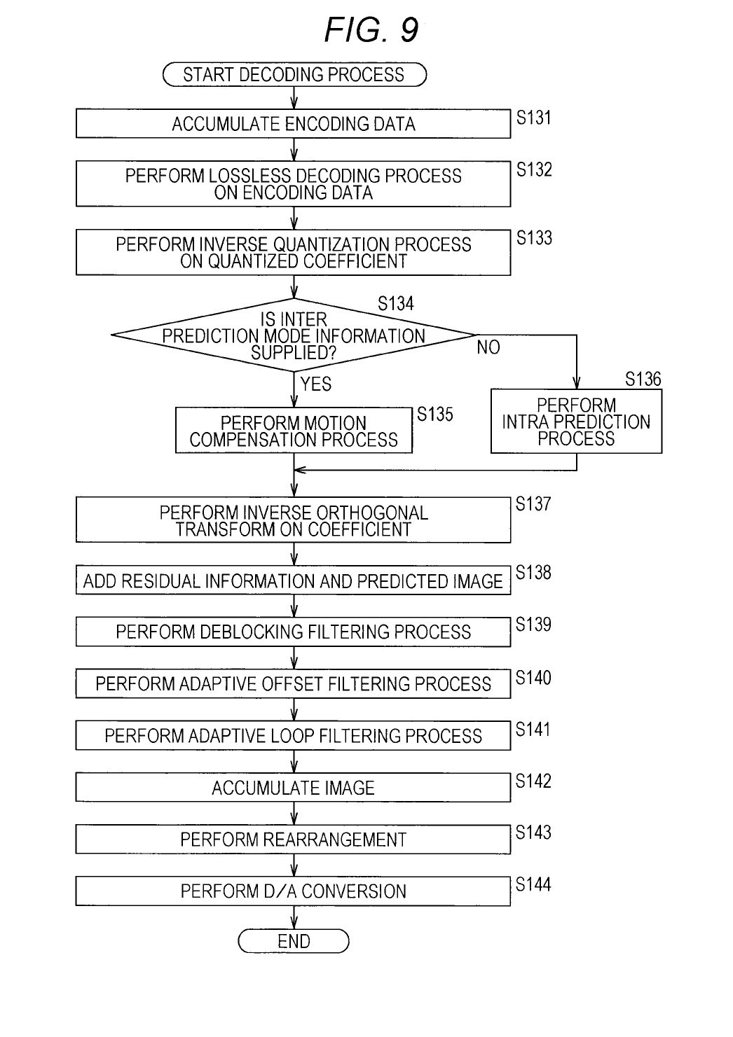

FIG. 9 is a flowchart illustrating details of a decoding process of the decoding device 113 illustrated in FIG. 8.

In step S131 illustrated in FIG. 9, the accumulation buffer 131 of the decoding device 113 receives the frame-unit encoding data transmitted from the encoding device 11 and accumulates the frame-unit encoding data. The accumulation buffer 131 supplies the accumulated encoding data to the lossless decoding unit 132.

In step S132, the lossless decoding unit 132 performs lossless decoding on the encoding data from the accumulation buffer 131 to obtain the quantized coefficient and the encoding information. The lossless decoding unit 132 supplies the quantized coefficient to the inverse quantization unit 133. In addition, the lossless decoding unit 132 supplies the intra prediction mode information or the like as the encoding information to the intra prediction unit 143 and supplies the motion vectors, the inter prediction mode information, the information for identifying the reference image, and the like to the motion compensation unit 144.

In addition, the lossless decoding unit 132 supplies the intra prediction mode information or the inter prediction mode information as the encoding information to the switch 145. The lossless decoding unit 132 supplies the offset filter information as the encoding information to the adaptive offset filter 137 and supplies the filter coefficient to the adaptive loop filter 138.

In step S133, the inverse quantization unit 133 performs inverse quantization on the quantized coefficient from the lossless decoding unit 132 and supplies the orthogonal transform coefficient obtained as a result thereof to the inverse orthogonal transform unit 134.

In step S134, the motion compensation unit 144 determines whether or not the inter prediction mode information is supplied from the lossless decoding unit 132. In the case where it is determined in step S134 that the inter prediction mode information is supplied, the process proceeds to step S135.

In step S135, the motion compensation unit 144 reads out the reference image based on the information for identifying the reference image supplied from the lossless decoding unit 132 and performs a motion compensation process in the optimal inter prediction mode indicated by the inter prediction mode information by using the motion vector and the reference image. The motion compensation unit 144 supplies the predicted image generated as a result thereof to the addition unit 135 through the switch 145, and the process proceeds to step S137.

On the other hand, in the case where it is determined in step S134 that the inter prediction mode information is not supplied, that is, in the case where the intra prediction mode information is supplied to the intra prediction unit 143, the process proceeds to step S136.

In step S136, the intra prediction unit 143 performs an intra prediction process in the intra prediction mode indicated by the intra prediction mode information by using the reference image read out from the frame memory 141 through the switch 142. The intra prediction unit 143 supplies the predicted image generated as a result of the intra prediction process to the addition unit 135 through the switch 145, and the process proceeds to step S137.

In step S137, the inverse orthogonal transform unit 134 performs inverse orthogonal transform on the orthogonal transform coefficient from the inverse quantization unit 133 and supplies the residual information obtained as a result thereof to the addition unit 135.

In step S138, the addition unit 135 adds the residual information supplied from the inverse orthogonal transform unit 134 and the predicted image supplied from the switch 145. The addition unit 135 supplies the image obtained as a result thereof to the deblocking filter 136 and supplies the image to the frame memory 141.

In step S139, the deblocking filter 136 performs a deblocking filtering process on the image supplied from the addition unit 135 to remove block distortion. The deblocking filter 136 supplies the image obtained as a result thereof to the adaptive offset filter 137.

In step S140, the adaptive offset filter 137 performs the adaptive offset filtering process in each LCU on the image after the deblocking filtering process of the deblocking filter 136 based on the offset filter information supplied from the lossless decoding unit 132. The adaptive offset filter 137 supplies the image after the adaptive offset filtering process to the adaptive loop filter 138.

In step S141, the adaptive loop filter 138 performs an adaptive loop filtering process on the image supplied from the adaptive offset filter 137 in each LCU by using the filter coefficient supplied from the lossless decoding unit 132. The adaptive loop filter 138 supplies the image obtained as a result thereof to the frame memory 141 and the screen rearrangement buffer 139.

In step S142, the frame memory 141 accumulates the image supplied from the addition unit 135 or the image supplied from the adaptive loop filter 138 by the method illustrated in FIGS. 2 to 5 similarly to the frame memory 44 illustrated in FIG. 1. The image accumulated in the frame memory 141 is supplied as the reference image to the motion compensation unit 144 or the intra prediction unit 143 through the switch 142.

In step S143, the screen rearrangement buffer 139 stores the images supplied from the adaptive loop filter 138 in units of a frame, rearranges the frame-unit images, which are stored in the order for encoding, in the original display order, and supplies the rearranged images to the D/A converter 140.

In step S144, the D/A converter 140 D/A-converts the frame-unit images supplied from the screen rearrangement buffer 139 and outputs the D/A-converted images as output signals, and after that, the process is ended.

As described above, similarly to the frame memory 44, the frame memory 141 of the decoding device 113 stores the decoded image by the method illustrated in FIGS. 3 to 5, so that it is possible to reduce the number of storable reference images down to 5. In addition, the frame memory 141 preferentially stores the decoded image of which display order is close to the display order of the encoding target image as the reference image by the method illustrated in FIGS. 3 and 4, so that in the case where the encoding target image is a moving image or the like, it is possible to suppress a deterioration in accuracy of the predicted image.

In addition, the frame memory 141 preferentially stores the decoded image of which quantization parameter is small as the reference image by the method illustrated in FIGS. 4 and 5, so that in the case where encoding target image is a still image or the like, it is possible to suppress a deterioration in accuracy of the predicted image.

(Application to Multiple Viewpoint Image Encoding/Multiple Viewpoint Image Decoding)

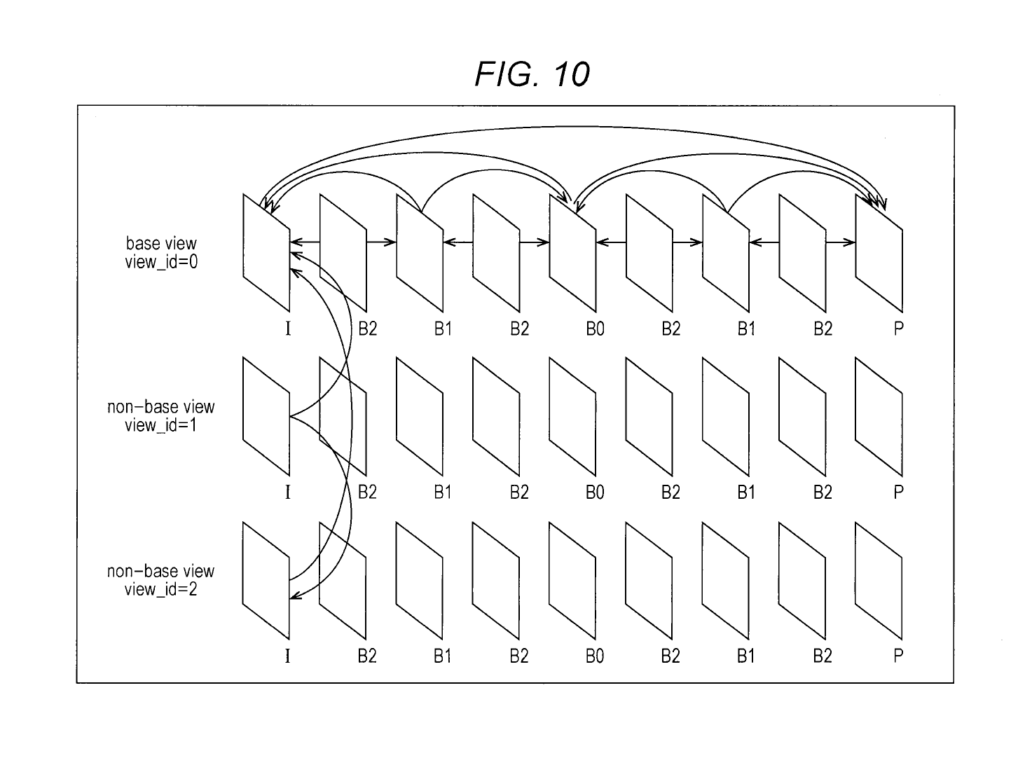

A series of the processes described above may be applied to multiple viewpoint image encoding/multiple viewpoint image decoding. FIG. 10 illustrates an example of a multiple viewpoint image encoding scheme.

As illustrated in FIG. 10, the multiple viewpoint image includes images of multiple viewpoints, and the image of a predetermined viewpoint among the multiple viewpoints is designated as an image of a base view. The image of each viewpoint other than the image of the base view is treated as an image of a non-base view.

In case of performing the multiple viewpoint image encoding illustrated in FIG. 10, the image of each view is encoded/decoded. However, the methods of the above-described embodiments may be applied to the encoding/decoding of each view. By performing the above-described processes, it is possible to suppress a deterioration in accuracy of the predicted image, and it is possible to reduce the number of storable reference images.

In addition, a difference between the quantization parameters may be taken in each view (the same view).

(1) base-view:

(1-1) dQP(base view)=Current_CU_QP(base view)−LCU_QP(base view)

(1-2) dQP(base view)=Current_CU_QP(base view)−Previsous_CU_QP(base view)

(1-3) dQP(base view)=Current_CU_QP(base view)−Slice_QP(base view)

(2) non-base-view:

(2-1) dQP(non-base view)=Current_CU_QP(non-base view)−LCU_QP(non-base view)

(2-2) dQP(non-base view)=CurrentQP(non-base view)−PrevisousQP(non-base view)

(2-3) dQP(non-base view)=Current_CU_QP(non-base view)−Slice_QP(non-base view)

In case of performing the multiple viewpoint image encoding, a difference between the quantization parameters may be taken in each view (different view).

(3) base-view/non-base view:

(3-1) dQP(inter-view)=Slice_QP(base view)−Slice_QP(non-base view)

(3-2) dQP(inter-view)=LCU_QP(base view)−LCU_QP(non-base view)

(4) non-base view/non-base view:

(4-1) dQP(inter-view)=Slice_QP(non-base view i)−Slice_QP(non-base view j)

(4-2) dQP(inter-view)=LCU_QP(non-base view i)−LCU_QP(non-base view j)

In this case, a combination of the above-described (1) to (4) may be used. For example, in the non-base view, a method (a combination of 3-1 and 2-3) of taking a difference in quantization parameter at a slice level between the base view and the non-base view and a method (a combination of 3-2 and 2-1) of taking a difference in quantization parameter at an LCU level between the base view and the non-base view are considered. In this manner, by repetitively applying the difference, even in the case where the multiple viewpoint encoding is performed, it is possible to improve an encoding efficiency.

Similarly to the above-described methods, a flag identifying whether or not a dQP of which value is not 0 exits may be set with respect to each dQP described above.

(Configuration Example of Multiple Viewpoint Image Encoding Device)

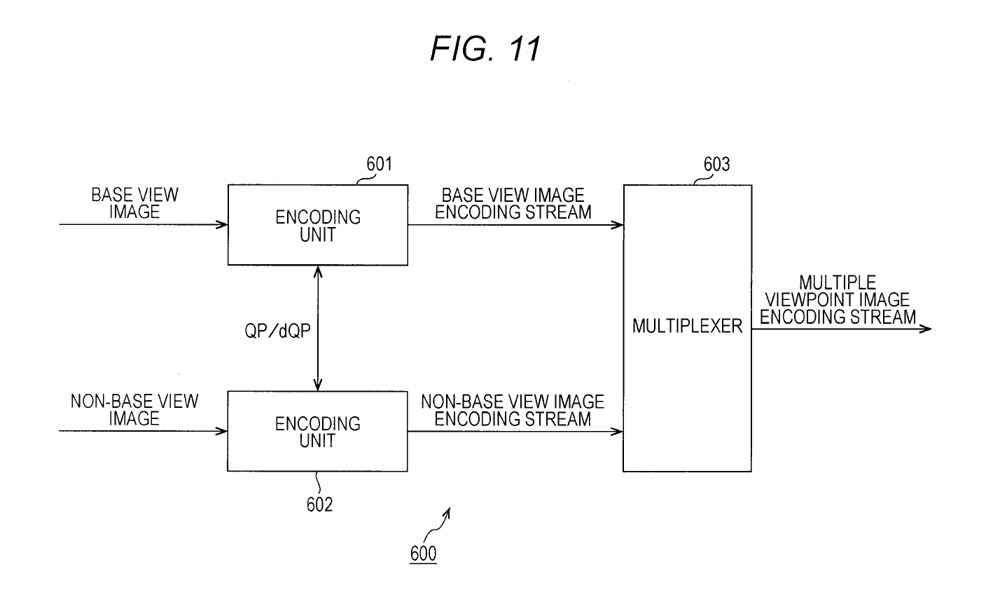

FIG. 11 is a diagram illustrating a multiple viewpoint image encoding device which performs the above-described multiple viewpoint image encoding. As illustrated in FIG. 11, the multiple viewpoint image encoding device 600 is configured to include an encoding unit 601, an encoding unit 602, and a multiplexer 603.

The encoding unit 601 encodes a base view image to generate a base view image encoding stream. The encoding unit 602 encodes a non-base view image to generate s non-base view image encoding stream. The multiplexer 603 multiplexes the base view image encoding stream generated in the encoding unit 601 and the non-base view image encoding stream generated in the encoding unit 602 to generate a multiple viewpoint image encoding stream.

The encoding device 11 may be applied to the encoding unit 601 and the encoding unit 602 of the multiple viewpoint image encoding device 600. In this case, the multiple viewpoint image encoding device 600 sets a difference value between the quantization parameter set by the encoding unit 601 and the quantization parameter set by the encoding unit 602 and transmits the difference value.

(Configuration Example of Multiple Viewpoint Image Decoding Device)

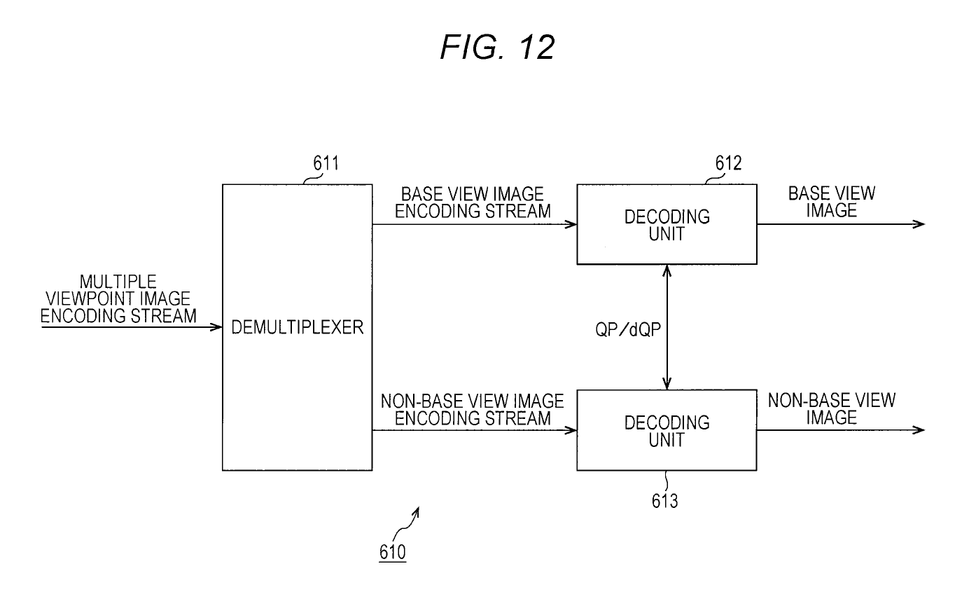

FIG. 12 is a diagram illustrating a multiple viewpoint image decoding device which performs the above-described multiple viewpoint image decoding. As illustrated in FIG. 12, the multiple viewpoint image decoding device 610 is configured to include a demultiplexer 611, a decoding unit 612, and a decoding unit 613.

The demultiplexer 611 demultiplexes a multiple viewpoint image encoding stream where a base view image encoding stream and a non-base view image encoding stream are multiplexed to extract the base view image encoding stream and the non-base view image encoding stream. The decoding unit 612 decodes a base view image encoding stream extracted by the demultiplexer 611 to obtain a base view image. The decoding unit 613 decodes a non-base view image encoding stream extracted by the demultiplexer 611 to obtain a non-base view image.

The decoding device 113 may be applied to the decoding unit 612 and the decoding unit 613 of the multiple viewpoint image decoding device 610. In this case, the multiple viewpoint image decoding device 610 sets a quantization parameter from a difference value between the quantization parameter set by the encoding unit 601 and the quantization parameter set by the encoding unit 602 and performs inverse quantization.

(Application to Hierarchical Image Encoding/Hierarchical Image Decoding)

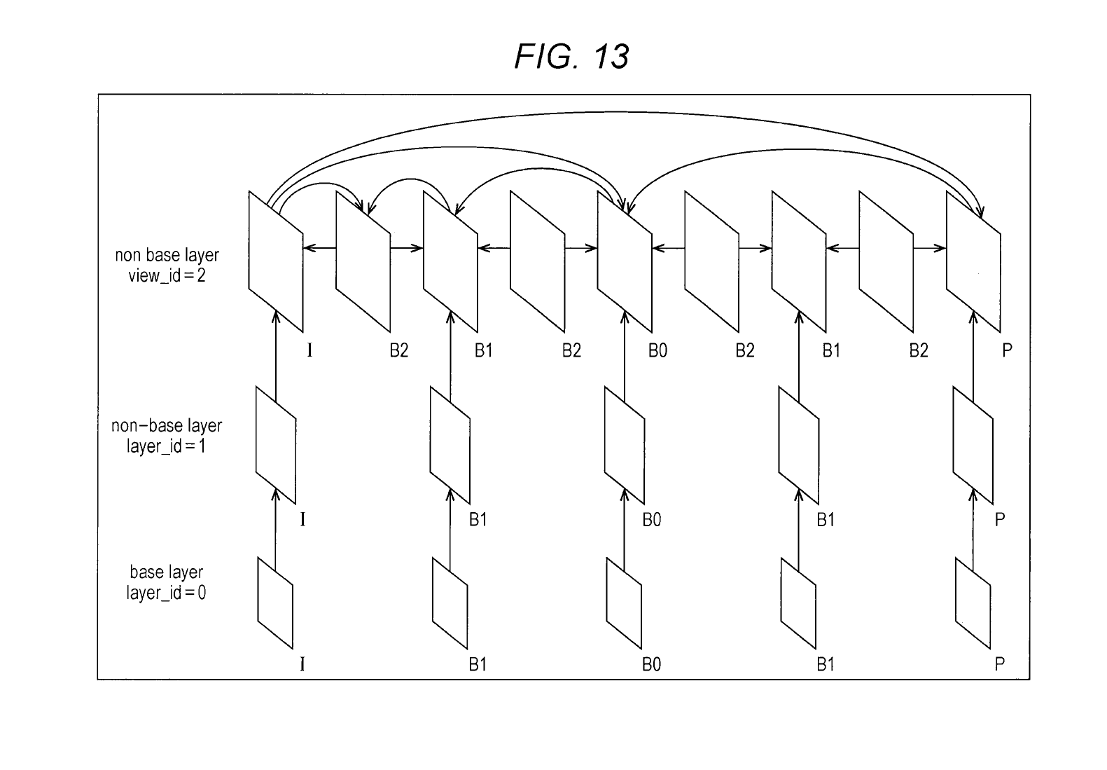

A series of the processes described above may be applied to hierarchical image encoding/hierarchical image decoding. FIG. 13 illustrates an example of a multiple viewpoint image encoding scheme.

As illustrated in FIG. 13, the hierarchical image includes images of multiple layers so as to have a scalability function for a predetermined parameter, and the image of a predetermined layer among the multiple layers is designated as an image of a base layer. The image of each layer other than the image of the base layer is treated as an image of a non-base layer.

In case of performing the hierarchical image encoding illustrated in FIG. 13, a difference of the quantization parameters may be taken in each layer (the same layer).

(1) base-layer:

(1-1) dQP(base layer)=Current_CU_QP(base layer)−LCU_QP(base layer)

(1-2) dQP(base layer)=Current_CU_QP(base layer)−Previsous_CU_QP(base layer)

(1-3) dQP(base layer)=Current_CU_QP(base layer)−Slice_QP(base layer)

(2) non-base-layer:

(2-1) dQP(non-base layer)=Current_CU_QP(non-base layer)−LCU_QP(non-base layer)

(2-2) dQP(non-base layer)=CurrentQP(non-base layer)−PrevisousQP(non-base layer)

(2-3) dQP(non-base layer)=Current_CU_QP(non-base layer)−Slice_QP(non-base layer)

In case of performing the hierarchical encoding, a difference between the quantization parameters may be taken in each layer (different layer).

(3) base-layer/non-base layer:

(3-1) dQP(inter-layer)=Slice_QP(base layer)−Slice_QP(non-base layer)

(3-2) dQP(inter-layer)=LCU_QP(base layer)−LCU_QP(non-base layer)

(4) non-base layer/non-base layer:

(4-1) dQP(inter-layer)=Slice_QP(non-base layer i)−Slice_QP(non-base layer j)

(4-2) dQP(inter-layer)=LCU_QP(non-base layer i)−LCU_QP(non-base layer j)

In this case, a combination of the above-described (1) to (4) may be used. For example, in the non-base layer, a method (a combination of 3-1 and 2-3) of taking a difference in quantization parameter at a slice level between the base layer and the non-base layer and a method (a combination of 3-2 and 2-1) of taking a difference in quantization parameter at an LCU level between the base layer and the non-base layer are considered. In this manner, by repetitively applying the difference, even in the case where the hierarchical encoding is performed, it is possible to improve an encoding efficiency.

Similarly to the above-described methods, a flag identifying whether or not a dQP of which value is not 0 exits may be set with respect to each dQP described above.

(To-be-Measured Parameters)

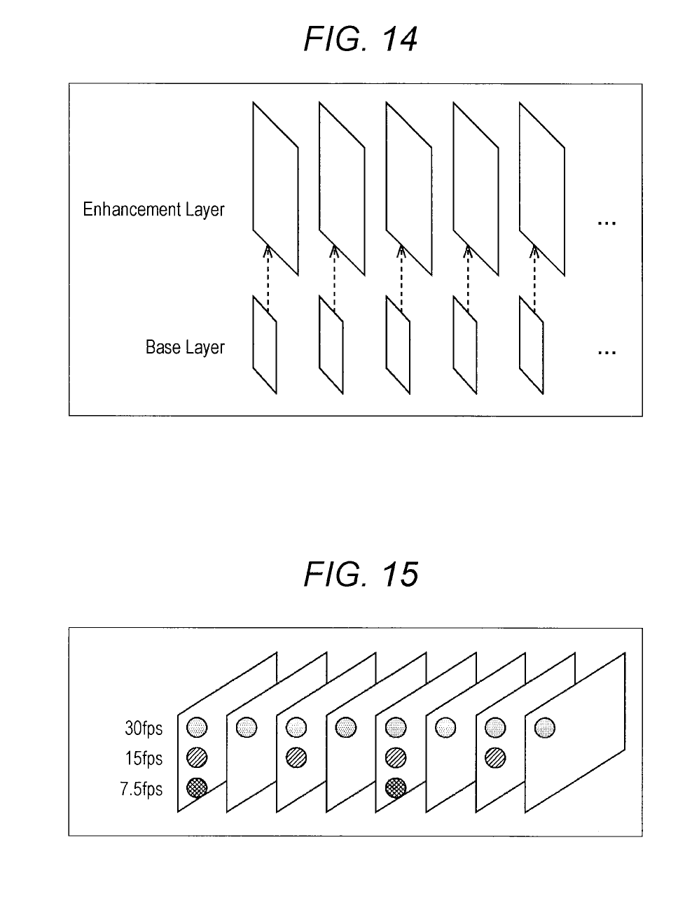

In the hierarchical image encoding/hierarchical image decoding (scalable encoding/scalable decoding), a parameter having a scalability function is arbitrary. For example, a spatial resolution illustrated in FIG. 14 may be defined as the parameter (spatial scalability). In case of the spatial scalability, the resolution of the image is different among the layers. Namely, in this case, as illustrated in FIG. 14, each picture is hierarchized into two layers of a base layer having a resolution lower than that of an original image and an enhancement layer having an original spatial resolution by combining with the base layer. The number of layers is exemplary, and each picture may be hierarchized into an arbitrary number of layers.

In addition, besides, as the parameters providing the scalability, for example, a temporal resolution illustrated in FIG. 15 may be applied (temporal scalability). In case of the temporal scalability, the frame rate is different among the layers. Namely, in this case, as illustrated in FIG. 15, each picture is hierarchized into two layers of a base layer having a resolution lower than that of an original moving image and an enhancement layer having an original frame rate by combining with the base layer. The number of layers is exemplary, and each picture may be hierarchized into an arbitrary number of layers.

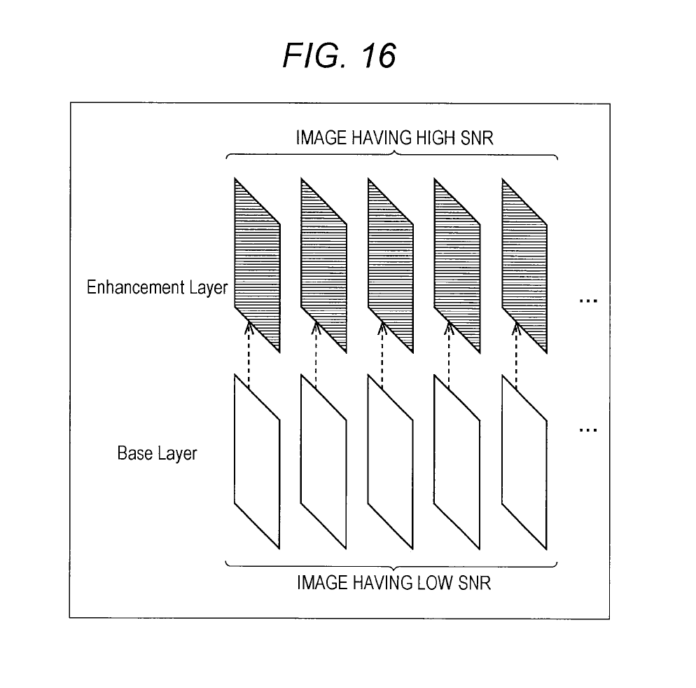

In addition, as the parameters providing the scalability, for example, a signal-to-noise ratio (SNR) may be applied (SNR scalability). In case of the SNR scalability, the SN ratio is different among the layers. Namely, in this case, as illustrated in FIG. 16, each picture is hierarchized into two layers of a base layer having an SNR lower than that of an original image and an enhancement layer having an original SNR by combining with the base layer. The number of layers is exemplary, and each picture may be hierarchized into an arbitrary number of layers.

Besides the above-described examples, other parameters providing the scalability may be used. For example, as the parameters providing the scalability, a bit depth may also be used (bit-depth scalability). In case of the bit-depth scalability, the bit depth is different among the layers. In this case, for example, the base layer is configured with an 8-bit image, and by adding the enhancement layer to the base layer, a 10-bit image may be obtained.

In addition, as the parameters providing the scalability, a chroma format may also be used (chroma scalability). In case of the chroma scalability, the chroma format is different among the layers. In this case, for example, the base layer is configured with a 4:2:0-format component image, and by adding the enhancement layer to the base layer, a 4:2:2-format component image may be obtained.

(Configuration Example of Hierarchical Image Encoding Device)

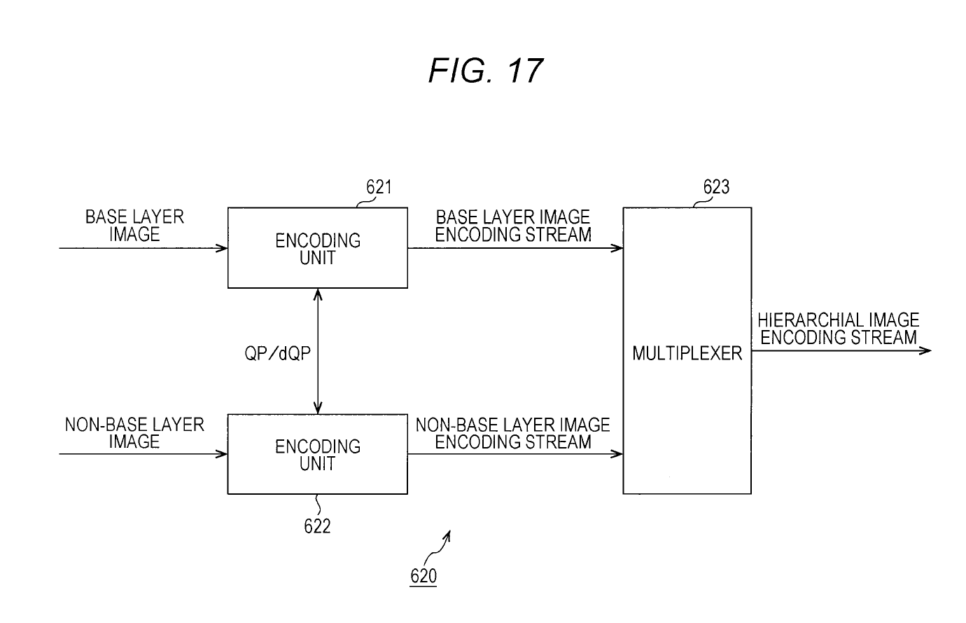

FIG. 17 is a diagram illustrating a hierarchical image encoding device which performs the above-described hierarchical image encoding. As illustrated in FIG. 17, the hierarchical image encoding device 620 is configured to include an encoding unit 621, an encoding unit 622, and a multiplexer 623.

The encoding unit 621 encodes a base layer image to generate a base layer image encoding stream. The encoding unit 622 encodes a non-base layer image to generate a non-base layer image encoding stream. The multiplexer 623 multiplexes the base layer image encoding stream generated in the encoding unit 621 and the non-base layer image encoding stream generated in the encoding unit 622 to generate a hierarchical image encoding stream.

The encoding device 11 may be applied to the encoding unit 621 and the encoding unit 622 of the hierarchical image encoding device 620. In this case, the hierarchical image encoding device 620 sets a difference value between the quantization parameter set by the encoding unit 621 and the quantization parameter set by the encoding unit 622 and transmits the difference value.

(Configuration Example of Hierarchical Image Decoding Device)

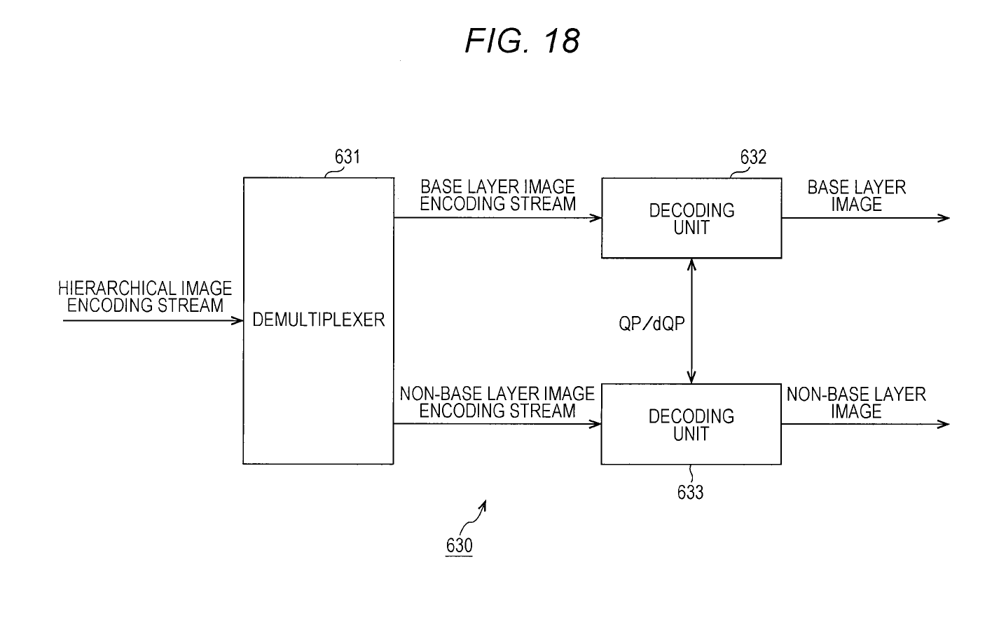

FIG. 18 is a diagram illustrating a hierarchical image decoding device which performs the above-described hierarchical image decoding. As illustrated in FIG. 18, the hierarchical image decoding device 630 is configured to include a demultiplexer 631, a decoding unit 632, and a decoding unit 633.

The demultiplexer 631 demultiplexes a hierarchical image encoding stream where a base layer image encoding stream and a non-base layer image encoding stream are multiplexed to extract the base layer image encoding stream and the non-base layer image encoding stream. The decoding unit 632 decodes the base layer image encoding stream extracted by the demultiplexer 631 to obtain a base layer image. The decoding unit 633 decodes the non-base layer image encoding stream extracted by the demultiplexer 631 to obtain a non-base layer image.

The decoding device 113 may be applied to the decoding unit 632 and the decoding unit 633 of the hierarchical image decoding device 630. In this case, hierarchical image decoding device 630 sets a quantization parameter from a difference value between the quantization parameter set by the encoding unit 621 and the quantization parameter set by the encoding unit 622 and performs inverse quantization.

(Description of Computer Employing the Present Technique)

A series of the above-described processes may be executed by hardware or by software. In the case where a series of the processes is executed by software, a program constituting the software is installed in a computer. Herein, the computer includes a computer which is assembled in dedicated hardware, a general-purpose personal computer where various programs are installed to execute various functions, and the like.

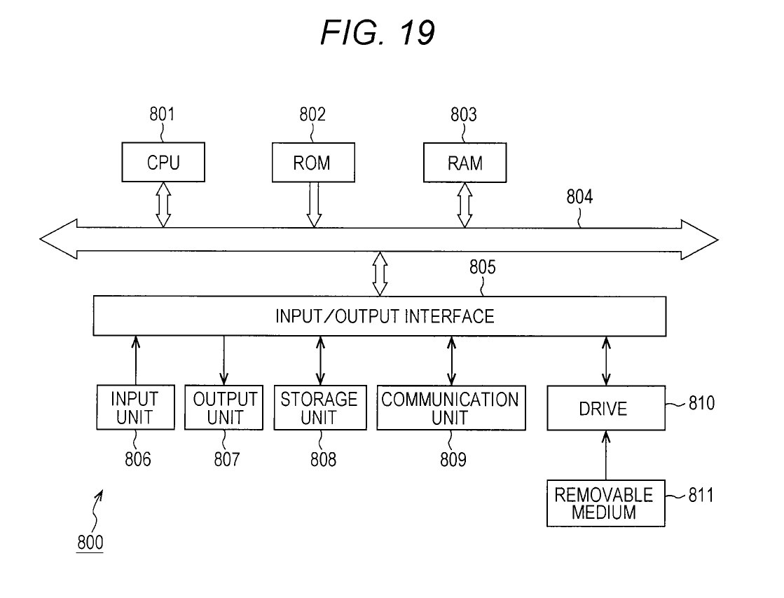

FIG. 19 is a block diagram illustrating a configuration example of hardware of the computer which executes a series of the above-described processes by a program.

In the computer, a central processing unit (CPU) 801, a read only memory (ROM) 802, and a random access memory (RAM) 803 are connected to each other via a bus 804.

In addition, an input/output interface 805 is connected to the bus 804. An input unit 806, an output unit 807, a storage unit 808, a communication unit 809, and a drive 810 are connected to the input/output interface 805.

The input unit 806 is configured with a keyboard, a mouse, a microphone, or the like. The output unit 807 is configured with a display, a speaker, or the like. The storage unit 808 is configured with a hard disk, a non-volatile memory, or the like. The communication unit 809 is configured with a network interface or the like. The drive 810 drives a removable medium 811 such as a magnetic disk, an optical disk, an optical magnetic disk, or a semiconductor memory.

In the computer having the above-described configuration, for example, the CPU 801 loads a program stored in the storage unit 808 on the RAM 803 through the input/output interface 805 and the bus 804 and executes the program, so that a series of the above-described processes are performed.

The program executed by the computer (CPU 801) may be provided in a manner that the program is recorded in the removable medium 811, for example, a package medium, or the like. In addition, the program may be provided through a wired or wireless transmission medium such as a local area network, the Internet, or digital satellite broadcasting.

In the computer, the removable medium 811 is mounted on the drive 810, so that the program may be installed in the storage unit 808 through the input/output interface 805. In addition, the program may be received by the communication unit 809 through the wired or wireless transmission medium to be installed in the storage unit 808. Otherwise, the program may be installed in the ROM 802 or the storage unit 808 in advance.

In addition, the program executed by the computer may be a program which performs processes in time sequence according to a procedure described in the specification, or the program may be a program which performs processes in parallel or at a necessary timing such as a time when a call is made.

(Configuration Example of Television Apparatus)

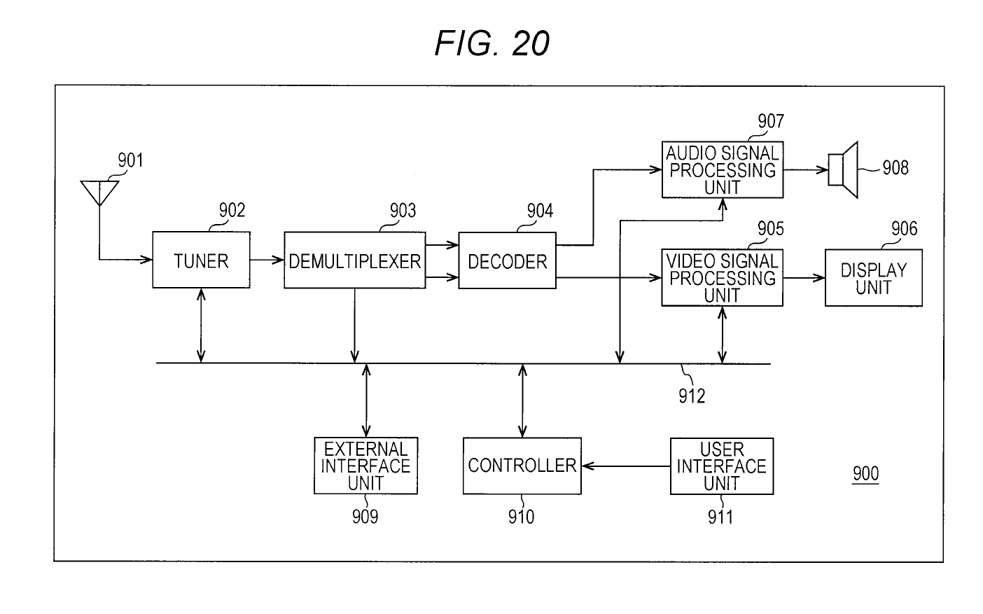

FIG. 20 illustrates an example of a schematic configuration of a television apparatus employing the present technique. The television apparatus 900 is configured to include an antenna 901, a tuner 902, a demultiplexer 903, a decoder 904, a video signal processing unit 905, a display unit 906, an audio signal processing unit 907, a speaker 908, and an external interface unit 909. In addition, the television apparatus 900 is configured to further include a controller 910, a user interface unit 911, and the like.

The tuner 902 selects a desired channel from broadcast wave signals received through the antenna 901 to perform demodulation and outputs an obtained encoded bit stream to the demultiplexer 903.

The demultiplexer 903 extracts video or audio packets of a program which is to be viewed from the encoded bit stream and outputs data of the extracted packets to the decoder 904. In addition, the demultiplexer 903 supplies the packets of the data such as an electronic program guide (EPG) to the controller 910. In addition, in case of performing scrambling, descrambling is performed by the demultiplexer or the like.

The decoder 904 performs a packet decoding process and outputs video data generated by the decoding process to the video signal processing unit 905 and outputs audio data to the audio signal processing unit 907.

The video signal processing unit 905 performs noise removing, video processing according to user setting, or the like on the video data. The video signal processing unit 905 generates video data of the program displayed on the display unit 906, image data by a process based on an application supplied through the network, or the like. In addition, the video signal processing unit 905 generates video data for displaying a menu screen of item selection and the like and overlaps the video data of the program with the video data for displaying the menu screen. The video signal processing unit 905 generates a drive signal based on the video data generated above to drive the display unit 906.

The display unit 906 drives a display device (for example, a liquid crystal display device or the like) based on the drive signal from the video signal processing unit 905 to display the video and the like of the program.

The audio signal processing unit 907 applies a predetermined process such as noise removing on the audio data, performs a D/A conversion process or an amplification process on the audio data after the process, and supplies the audio data to the speaker 908, so that the audio outputting is performed.

The external interface unit 909 is an interface for connecting to an external device or a network and performs data transmission/reception of the video data, the audio data, and the like.

The user interface unit 911 is connected to the controller 910. The user interface unit 911 is configured with a manipulation switch, a remote control signal reception unit, and the like and supplies a manipulation signal according to user manipulation to the controller 910.

The controller 910 is configured by using a central processing unit (CPU), a memory, and the like. The memory stores programs executed by the CPU, various data necessary for the CPU to perform processes, EPG data, data acquired through the network, or the like. The program stored in the memory is read out and executed by the CPU at a predetermined timing such as a startup time of the television apparatus 900. The CPU executes the program to control each component so that the television apparatus 900 is operated according to user manipulation.

In addition, in the television apparatus 900, a bus 912 is installed so as to connect the controller 910 to the tuner 902, the demultiplexer 903, the video signal processing unit 905, the audio signal processing unit 907, the external interface unit 909, and the like.

In the television apparatus having the above-described configuration, the functions of the image processing apparatus (image processing method) according to the present application are installed in the decoder 904. Therefore, it is possible to suppress a deterioration in accuracy of the predicted image, and it is possible to reduce the number of storable reference images.

(Configuration Example of Mobile Phone)

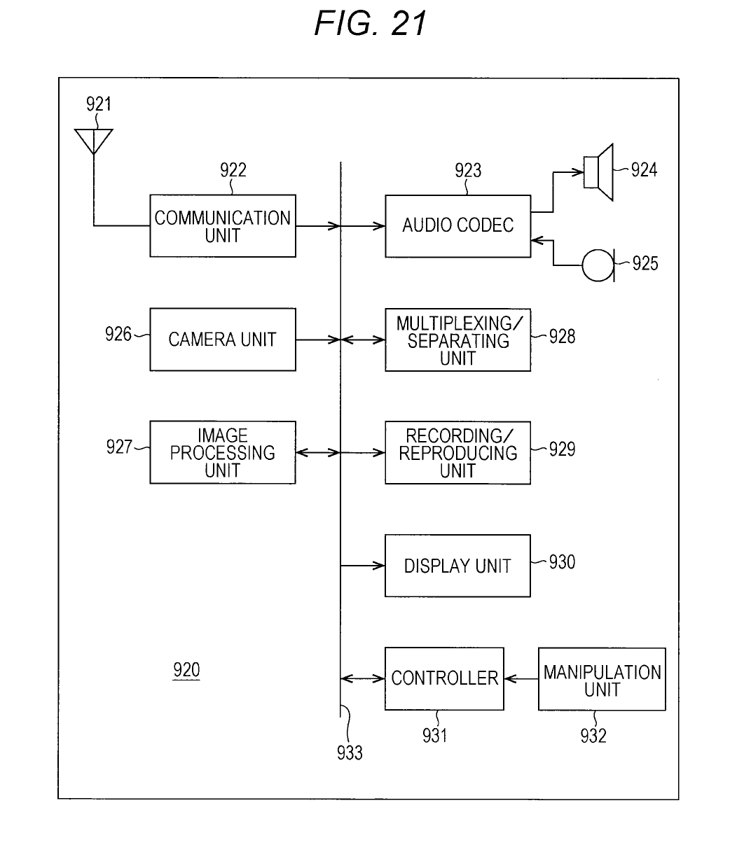

FIG. 21 illustrates an example of a schematic configuration of a mobile phone employing the present technique. The mobile phone 920 is configured to include a communication unit 922, an audio codec 923, a camera unit 926, an image processing unit 927, a multiplexing/separating unit 928, a recording/reproducing unit 929, a display unit 930, and a controller 931. These components are connected to each other via a bus 933.

In addition, an antenna 921 is connected to the communication unit 922, and a speaker 924 and a microphone 925 are connected to the audio codec 923. In addition, a manipulation unit 932 is connected to the controller 931.

The mobile phone 920 performs various operations such as transmission/reception of audio signals, transmission/reception of electronic mails or image data, image capturing, or data recording in various modes such as an audio communication mode or a data communication mode.

In the audio communication mode, the audio signal generated by the microphone 925 is converted into audio data or data-compressed by the audio codec 923 and is supplied to the communication unit 922. The communication unit 922 performs a modulation process, a frequency conversion process, and the like on the audio data to generate a transmission signal. In addition, the communication unit 922 supplies the transmission signal to the antenna 921 to transmit the transmission signal to a base station (not shown). In addition, the communication unit 922 performs amplification, a frequency conversion process, a demodulation process, and the like on a reception signal received through the antenna 921 and supplies the obtained audio data to the audio codec 923. The audio codec 923 performs data decompression of the audio data or conversion of the audio data to an analog audio signal and outputs the obtained signal to the speaker 924.

In addition, in the data communication mode, in case of performing mail transmission, the controller 931 receives character data input by manipulation of the manipulation unit 932 and displays the input characters on the display unit 930. In addition, the controller 931 generates mail data based on user instruction or the like in the manipulation unit 932 and supplies the mail data to the communication unit 922. The communication unit 922 performs a modulation process, a frequency conversion process, and the like on the mail data and transmits the obtained transmission signal from the antenna 921. In addition, the communication unit 922 performs amplification, a frequency conversion process, a demodulation process, and the like on a reception signal received through the antenna 921 to restore the mail data. The mail data are supplied to the display unit 930, so that displaying of a content of the mail is performed.

In addition, the mobile phone 920 may also store the received mail data in a storage medium by using the recording/reproducing unit 929. The storage medium is an arbitrary rewritable storage medium. For example, the storage medium is a semiconductor memory such as a RAM or a built-in flash memory, a removable medium such as a hard disk, a magnetic disk, an optical magnetic disk, an optical disk, a USB memory, or a memory card, or the like.

In the case where the image data are transmitted in the data communication mode, the image data generated by the camera unit 926 are supplied to the image processing unit 927. The image processing unit 927 performs an encoding process on the image data to generate encoding data.

The multiplexing/separating unit 928 multiplexes the encoding data generated by the image processing unit 927 and the audio data supplied from the audio codec 923 in a predetermined scheme and supplies the multiplexed data to the communication unit 922. The communication unit 922 performs a modulation process, a frequency conversion process, and the like on the multiplexed data and transmits the obtained transmission signal from the antenna 921. In addition, the communication unit 922 performs amplification, a frequency conversion process, a demodulation process, and the like on a reception signal received through the antenna 921 to restore the multiplexed data. The multiplexed data are supplied to the multiplexing/separating unit 928. The multiplexing/separating unit 928 performs separation on the multiplexed data, supplies the encoding data to the image processing unit 927, and supplies the audio data to the audio codec 923. The image processing unit 927 performs a decoding process on the encoding data to generate the image data. The image data are supplied to the display unit 930, so that displaying of the received image is performed. The audio codec 923 converts the audio data into an analog audio signal and supplies the analog audio signal to the speaker 924 to output the received audio.

In the mobile phone apparatus having the above-described configuration, the functions of the image processing apparatus (image processing method) according to the present application are installed in the image processing unit 927. Therefore, it is possible to suppress a deterioration in accuracy of the predicted image, and it is possible to reduce the number of storable reference images.

(Configuration Example of Recording/Reproducing Apparatus)

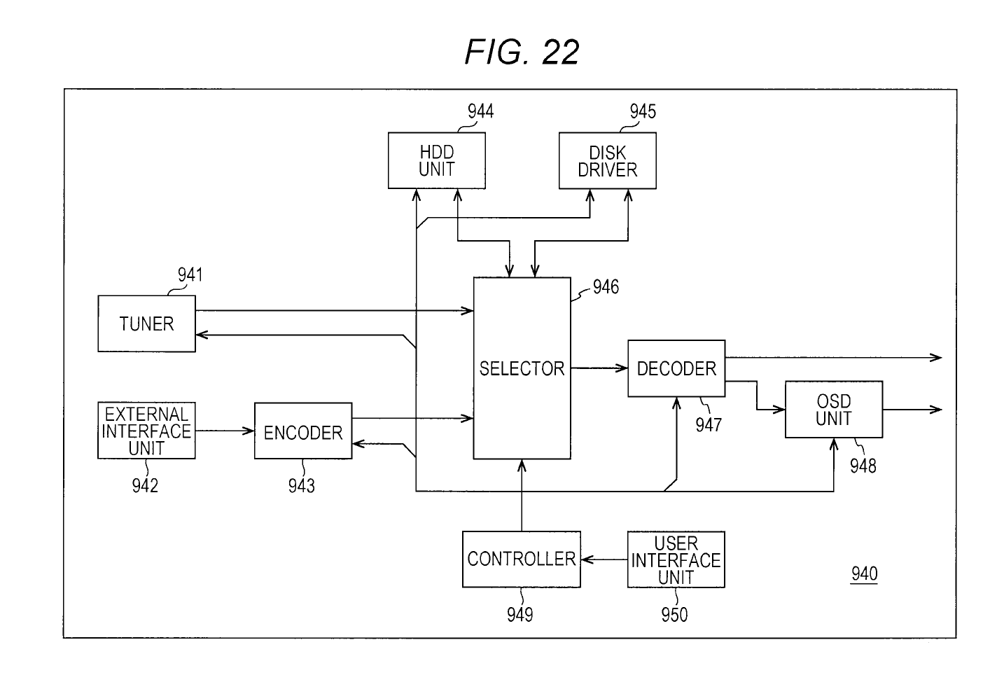

FIG. 22 illustrates an example of a schematic configuration of a recording/reproducing apparatus employing the present technique. The recording/reproducing apparatus 940, for example, records audio data and video data of a received broadcast program in a recording medium and provides the recorded data to a user at a timing according to user instruction. In addition, the recording/reproducing apparatus 940, for example, may acquire audio data or video data from another apparatus and record the data in the recording medium. In addition, the recording/reproducing apparatus 940 decodes the audio data or the video data recorded in the recording medium and outputs the decoded data, so that image displaying on a monitor device or the like or audio outputting may be performed.

The recording/reproducing apparatus 940 is configured to include a tuner 941, an external interface unit 942, an encoder 943, a hard disk drive (HDD) unit 944, a disk driver 945, a selector 946, a decoder 947, an on-screen display (OSD) unit 948, a controller 949, and a user interface unit 950.

The tuner 941 selects a desired channel from broadcast signals received through an antenna (not shown). The tuner 941 outputs an encoded bit stream obtained by demodulating a reception signal of the desired channel to the selector 946.

The external interface unit 942 is configured with at least one of an IEEE1394 interface, a network interface unit, a USB interface, a flash memory interface, and the like. The external interface unit 942 is an interface for connecting to an external device, a network, a memory card, or the like and performs data reception of to-be-recorded video data, audio data, and the like.

The encoder 943 performs encoding on the video data or the audio data in a predetermined scheme when the video data or the audio data supplied from the external interface unit 942 are not encoded and outputs an encoded bit stream to the selector 946.

The HDD unit 944 records contents data of video, audio, and the like, various programs, other data, and the like in a built-in hard disk and reads out the data and the like from the hard disk at a reproducing time or the like.

The disk driver 945 performs signal recording and signal reproducing on a mounted optical disk. The optical disk is, for example, a DVD disk (DVD-Video, DVD-RAM, DVD-R, DVD-RW, DVD+R, DVD+RW, or the like), a Blu-ray (registered trade mark) disk, or the like.

At a recording time of video or audio, the selector 946 selects an encoded bit stream from any of the tuner 941 and the encoder 943 and supplies the encoded bit stream to any of the HDD unit 944 and the disk driver 945. In addition, at a reproducing time of video or audio, the selector 946 supplies the encoded bit stream output from the HDD unit 944 or the disk driver 945 to the decoder 947.

The decoder 947 performs a decoding process on the encoded bit stream. The decoder 947 supplies the video data generated by performing the decoding process to the OSD unit 948. In addition, the decoder 947 outputs the audio data generated by performing the decoding process.

The OSD unit 948 generates video data for displaying a menu screen of item selection and the like and overlaps the video data output from the decoder 947 with the video data for displaying the menu screen to output the video data.

The user interface unit 950 is connected to the controller 949. The user interface unit 950 is configured with a manipulation switch, a remote control signal reception unit, and the like and supplies a manipulation signal according to user manipulation to the controller 949.

The controller 949 is configured by using a CPU, a memory, and the like. The memory stores programs executed by the CPU or various data necessary for the CPU to perform processes. The program stored in the memory is read out and executed by the CPU at a predetermined timing such as a startup time of the recording/reproducing apparatus 940. The CPU executes the program to control each component so that the recording/reproducing apparatus 940 is operated according to user manipulation.

In the recording/reproducing apparatus having the above-described configuration, the functions of the image processing apparatus (image processing method) according to the present application are installed in the decoder 947. Therefore, it is possible to suppress a deterioration in accuracy of the predicted image, and it is possible to reduce the number of storable reference images.

(Configuration Example of Imaging Apparatus)

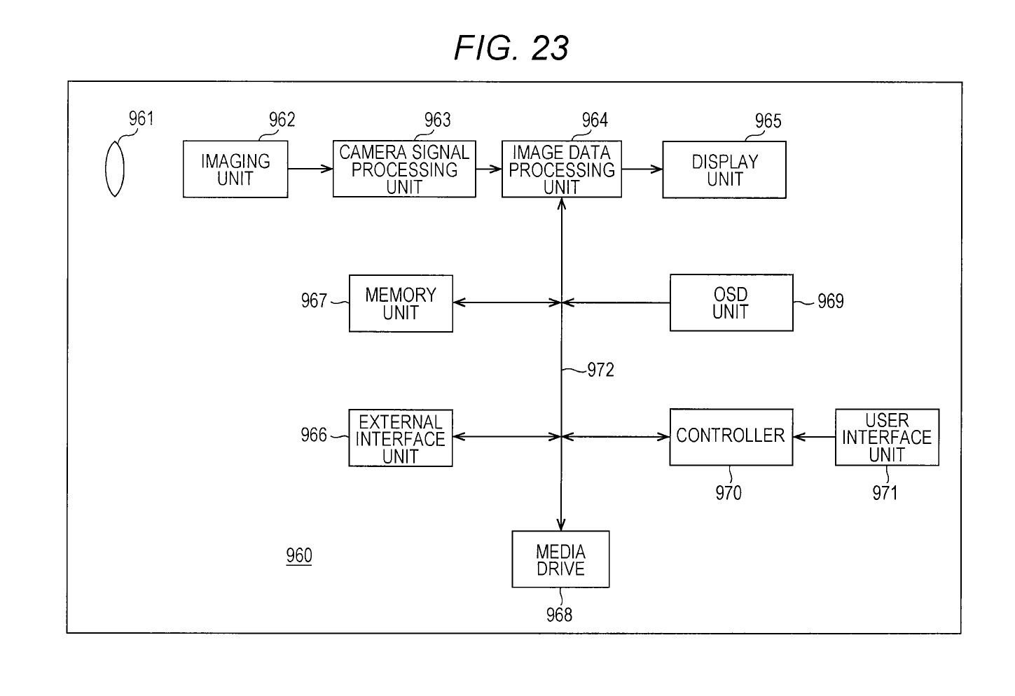

FIG. 23 illustrates an example of a schematic configuration of an imaging apparatus employing the present technique. The imaging apparatus 960 captures an image of an object to display the image of the object on a display unit or to record the image of the object as image data in a recording medium.

The imaging apparatus 960 is configured to include an optical block 961, an imaging unit 962, a camera signal processing unit 963, an image data processing unit 964, a display unit 965, an external interface unit 966, a memory unit 967, a media drive 968, an OSD unit 969, and a controller 970. In addition, a user interface unit 971 is connected to the controller 970. In addition, the image data processing unit 964, the external interface unit 966, the memory unit 967, the media drive 968, the OSD unit 969, the controller 970, and the like are connected to each other via a bus 972.

The optical block 961 is configured by using a focus lens, a stop, and the like. The optical block 961 focuses an optical image of the object on an image plane of the imaging unit 962. The imaging unit 962 is configured by using a CCD or CMOS image sensor and generates an electric signal according to the optical image through photoelectric conversion to supply the electric signal to the camera signal processing unit 963.

The camera signal processing unit 963 performs various camera signal processes such as knee correction, gamma correction, and color correction on the electric signal supplied from the imaging unit 962. The camera signal processing unit 963 supplies the image data after the camera signal processing to the image data processing unit 964.

The image data processing unit 964 performs an encoding process of the image data supplied from the camera signal processing unit 963. The image data processing unit 964 supplies the encoding data generated by performing the encoding process to the external interface unit 966 or the media drive 968. In addition, the image data processing unit 964 performs a decoding process on the encoding data supplied from the external interface unit 966 or the media drive 968. The image data processing unit 964 supplies the image data generated by performing the decoding process to the display unit 965. In addition, the image data processing unit 964 supplies the image data supplied from the camera signal processing unit 963 to the display unit 965 or overlaps the image data with the data for display acquired from the OSD unit 969 and supplies the overlapped data to the display unit 965.

The OSD unit 969 generates the data for displaying such as menu screens and ions which are configured with symbols, characters, or figures and outputs the data for display to the image data processing unit 964.

The external interface unit 966 is configured with, for example, USB input/output ports and the like, and in case of printing images, the external interface unit 966 is connected to a printer. In addition, if necessary, a drive is connected to the external interface unit 966, and a removable medium such as a magnetic disk or an optical disk is appropriately mounted. A computer program read out from the removable medium is installed if necessary. In addition, the external interface unit 966 is configured to include a network interface which is connected to a predetermined network such as a LAN or the Internet. For example, the controller 970 may read out the encoding data from the media drive 968 according to instruction from the user interface unit 971 and supply the encoding data from the external interface unit 966 to other devices connected via the network. In addition, the controller 970 may acquire the encoding data or the image data supplied from other devices via the network through the external interface unit 966 and supply the encoding data or the image data to the image data processing unit 964.

As a recording medium driven by the media drive 968, for example, an arbitrary readable/writable removable medium such as a magnetic disk, an optical magnetic disk, an optical disk, or a semiconductor memory is used. In addition, the recording medium is arbitrary in terms of the type as the removable medium. The recording medium may be a tape device, a disk, or a memory card. In addition, the recording medium may be a non-contact integrated circuit (IC) card, or the like.

In addition, the media drive 968 and the recording medium are integrated, so that the recording medium may be configured with a non-portable storage medium such as a built-in hard disk drive or a solid state drive (SSD).

The controller 970 is configured by using a CPU. The memory unit 967 stores programs executed by the controller 970, various data necessary for the controller 970 to perform processes, or the like. The program stored in the memory unit 967 is read out and executed by the controller 970 at a predetermined timing such as a startup time of the imaging apparatus 960. The controller 970 executes the program to control each component so that the imaging apparatus 960 is operated according to user manipulation.

In the imaging apparatus having the above-described configuration, the functions of the image processing apparatus (image processing method) according to the present application are installed in the image data processing unit 964. Therefore, it is possible to suppress a deterioration in accuracy of the predicted image, and it is possible to reduce the number of storable reference images.

<Example of Application of Scalable Encoding>

(First System)

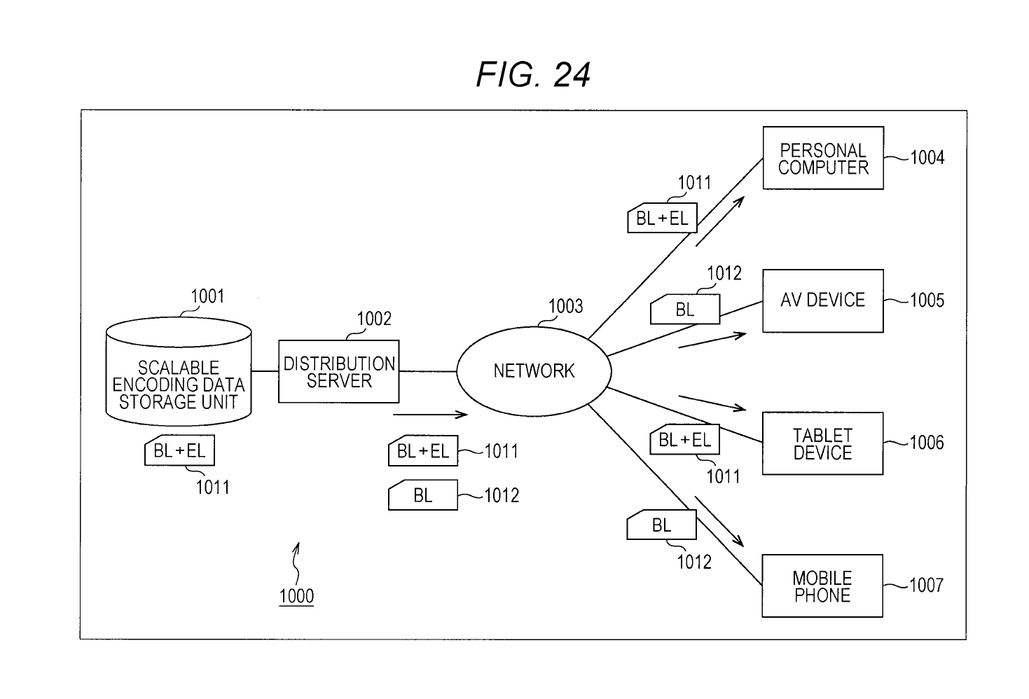

Next, a specific use example of scalable encoding data which are scalable-encoded (hierarchical-encoded) will be described. For example, like an example illustrated in FIG. 24, scalable encoding is used for selecting data which are to be transmitted.

In a data transmission system 1000 illustrated in FIG. 24, a distribution server 1002 reads out scalable encoding data stored in a scalable encoding data storage unit 1001 and distributes the scalable encoding data to terminal devices such as a personal computer 1004, an AV device 1005, a tablet device 1006, and a mobile phone 1007 via a network 1003.

At this time, the distribution server 1002 selects and transmits encoding data having an appropriate quality according to a capability of the terminal device, a communication environment, or the like. Although the distribution server 1002 unnecessarily transmits data having high quality, an image having a high image quality may not be obtained in the terminal device, and it may be a cause of occurrence of delay or overflow. In addition, a communication band may be unnecessarily occupied, or the load of the terminal device may be unnecessarily increased. On the contrary, although the distribution server 1002 unnecessarily transmits data having low quality, an image having a sufficient image quality may not be obtained in the terminal device. Therefore, the distribution server 1002 appropriately reads out the scalable encoding data stored in the scalable encoding data storage unit 1001 as the encoding data having a quality appropriate to a capability of the terminal device, communication environment, and the like and transmits the encoding data.

For example, the scalable encoding data storage unit 1001 stores scalable encoding data (BL+EL) 1011 which are scalable-encoded. The scalable encoding data (BL+EL) 1011 are encoding data including both of the base layer and the enhancement layer and data from which both of the image of the base layer and the image of the enhancement layer are obtained by decoding.

The distribution server 1002 selects an appropriate layer according to the capability of the terminal device which transmits the data, communication environment, and the like and reads out data of the layer. For example, with respect to the personal computer 1004 or the tablet device 1006 having a high processing capability, the distribution server 1002 reads out the scalable encoding data (BL+EL) 1011 having a high quality from the scalable encoding data storage unit 1001 and transmits the scalable encoding data (BL+EL) 1011 without change. On the contrary, for example, with respect to the AV device 1005 or the mobile phone 1007 having a low processing capability, the distribution server 1002 extracts the data of the base layer from the scalable encoding data (BL+EL) 1011 and transmits the data as scalable encoding data (BL) 1012 having a quality which is lower than that of the scalable encoding data (BL+EL) 1011 although the scalable encoding data (BL) 1012 are data of the same content as that of the scalable encoding data (BL+EL) 1011.

If the scalable encoding data is used in this manner, it is possible to easily adjust the data amount, so that it is possible to suppress occurrence of delay or overflow or to suppress an unnecessary increase in load of the terminal device or the communication medium. In addition, in the scalable encoding data (BL+EL) 1011, since redundancy between the layers is decreased, it is possible to reduce the data amount in comparison with the case where the encoding data of each layer are treated as individual data. Therefore, it is possible to efficiently use the storage area of the scalable encoding data storage unit 1001.

In addition, similarly to the personal computer 1004 to the mobile phone 1007, since various devices may be applied to the terminal device, hardware performance of the terminal device is different among the devices. In addition, since various applications may be executed by the terminal device, software capability is also different. In addition, since any communication network including a wired communication network, a wireless communication network, or both thereof such as the Internet or a local area network (LAN) may be applied to the network 1003 which is a communication medium, the data transmission capability is different. Furthermore, the data transmission capability may be changed according to other communications or the like.

Therefore, before starting the data transmission, the distribution server 1002 may perform communication with the terminal device which is a destination of the data transmission to obtain information on the capabilities of the terminal device such as hardware performance of the terminal device or performance of applications (software) executed by the terminal device and information on the communication environment such as an available bandwidth of the network 1003. Next, the distribution server 1002 may select an appropriate layer based on the information obtained above.

In addition, layer extraction may be performed in the terminal device. For example, the personal computer 1004 may decode the transmitted scalable encoding data (BL+EL) 1011 to display the image of the base layer or to display the image of the enhancement layer. In addition, for example, the personal computer 1004 may extract the scalable encoding data (BL) 1012 of the base layer from the transmitted scalable encoding data (BL+EL) 1011 to store the scalable encoding data (BL) 1012, to transmit the scalable encoding data (BL) 1012 to anther device, or to decode the scalable encoding data (BL) 1012 to display the image of the base layer.

Of course, the number of scalable encoding data storage units 1001, the number of distribution servers 1002, the number of networks 1003, and the number of terminal devices are arbitrary. In addition, heretofore, although the example where the distribution server 1002 transmits data to the terminal device is described, the use example is not limited thereto. The data transmission system 1000 may be applied to an arbitrary system which selects an appropriate layer according to the capabilities of the terminal device, the communication environment, and the like and performs transmission when the data transmission system 1000 transmits the scalable-encoded encoding data to the terminal device.

(Second System)

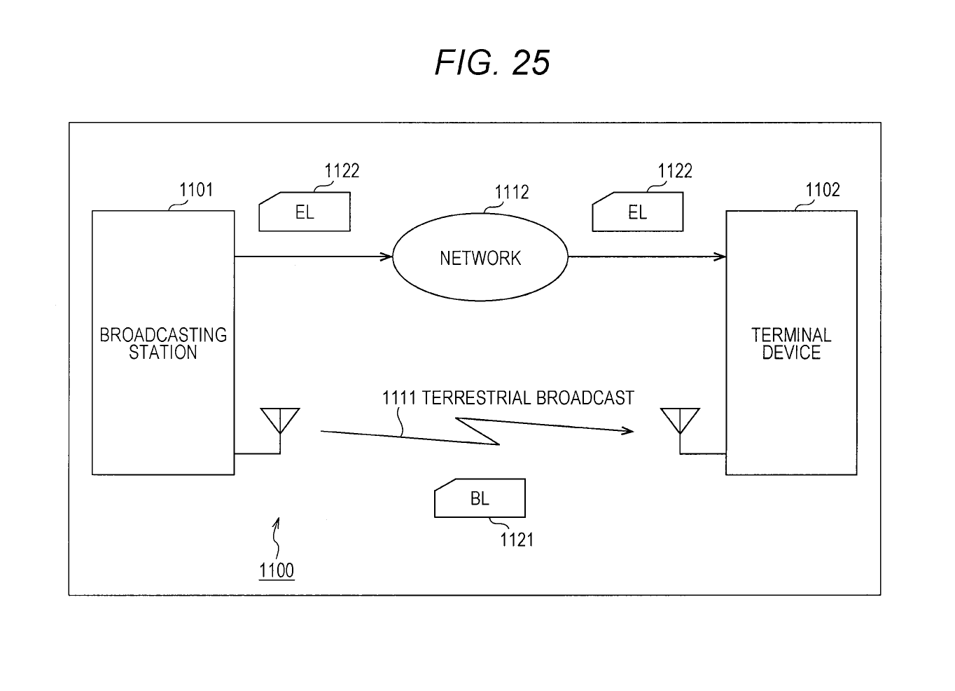

In addition, for example, like an example illustrated in FIG. 25, the scalable encoding is used for transmission via a plurality of communication media.

In a data transmission system 1100 illustrated in FIG. 25, a broadcasting station 1101 transmits scalable encoding data (BL) 1121 of a base layer through terrestrial broadcast 1111. In addition, the broadcasting station 1101 transmits a scalable encoding data (EL) 1122 of an enhancement layer via an arbitrary network 1112 configured with a wired communication network, a wireless communication network, or both thereof (for example, transmits packetized data).

The terminal device 1102 has a reception function of the terrestrial broadcast 1111 broadcast by the broadcasting station 1101 to receive the scalable encoding data (BL) 1121 of the base layer transmitted through the terrestrial broadcast 1111. In addition, the terminal device 1102 further has a communication function of implementing communication via the network 1112 to receive the scalable encoding data (EL) 1122 of the enhancement layer transmitted via the network 1112.

The terminal device 1102 obtains the image of base layer by decoding the scalable encoding data (BL) 1121 of the base layer acquired through the terrestrial broadcast 1111, stores the data, or transmits the data to other devices, for example, according to user instruction or the like.

In addition, the terminal device 1102 obtains the scalable encoding data (BL+EL) by combining the scalable encoding data (BL) 1121 of the base layer acquired through the terrestrial broadcast 1111 and the scalable encoding data (EL) 1122 of the enhancement layer acquired through the network 1112, obtains the image of the enhancement layer by decoding the data, stores the data, or transmits the data to other devices, for example, according to user instruction or the like.

In this manner, the scalable encoding data may be transmitted, for example, through different communication medium for each layer. Therefore, it is possible to share the load, so that it is possible to suppress occurrence of delay or overflow.

In addition, the communication medium used for transmission may be selected for each layer according to the situation. For example, the scalable encoding data (BL) 1121 of the base layer which has a relatively large data amount may be transmitted through the communication medium having a wide bandwidth, and the scalable encoding data (EL) 1122 of the enhancement layer which has a relatively small data amount may be transmitted through the communication medium having a narrow bandwidth. In addition, for example, the communication medium through which the scalable encoding data (EL) 1122 of the enhancement layer are to be transmitted may be switched between the network 1112 and the terrestrial broadcast 1111 according to the available bandwidth of the network 1112. Of course, the same is applied to data of an arbitrary layer.

By controlling in this manner, it is possible to further suppress increase in load of the data transmission.

Of course, the number of layers is arbitrary, and the number of communication media used for transmission is also arbitrary. In addition, the number of terminal devices 1102 which are destinations of data distribution is also arbitrary. In addition, heretofore, the example of broadcasting from the broadcasting station 1101 is described. However, the use example is not limited thereto. The data transmission system 1100 may be applied to an arbitrary system which separates the scalable-encoded encoding data into multiple data in units of a layer and transmits the data through multiple communication lines.

(Third System)

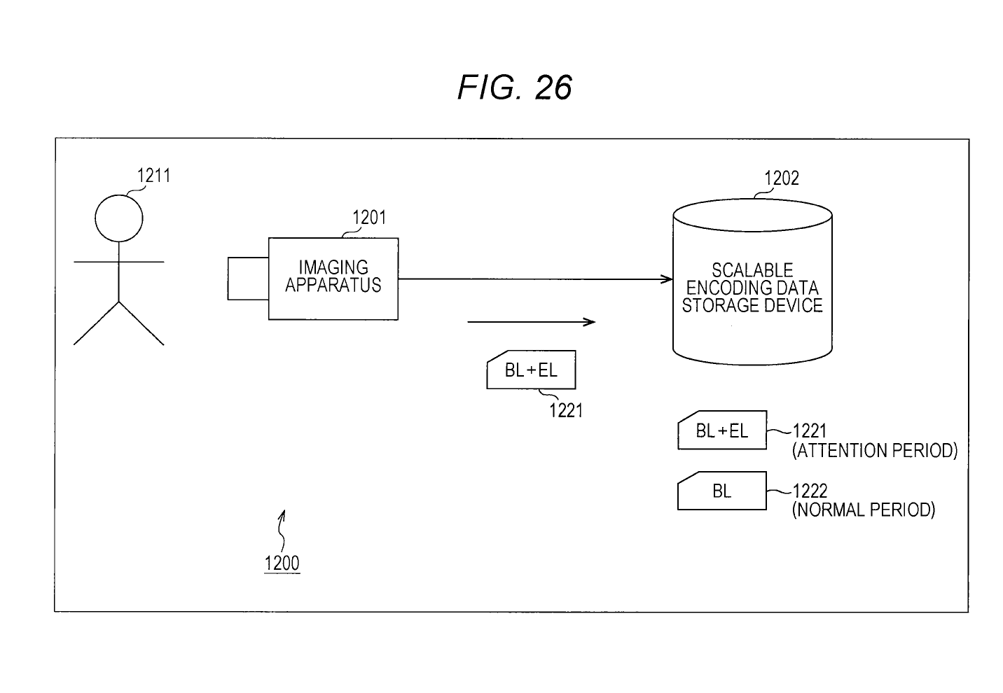

In addition, for example, like an example illustrated in FIG. 26, the scalable encoding is used for storing the encoding data.

In an imaging system 1200 illustrated in FIG. 26, an imaging apparatus 1201 performs scalable encoding on image data obtained by capturing an image of an object 1211 and supplies the data as scalable encoding data (BL+EL) 1221 to a scalable encoding data storage device 1202.

The scalable encoding data storage device 1202 stores the scalable encoding data (BL+EL) 1221 supplied from the imaging apparatus 1201 with a quality according to a situation. For example, in case of a normal period, the scalable encoding data storage device 1202 extracts data of a base layer from the scalable encoding data (BL+EL) 1221 and stores the data as scalable encoding data (BL) 1222 of the base layer having a small data amount with a low quality. On the contrary, for example, in case of an attention period, the scalable encoding data storage device 1202 stores the scalable encoding data (BL+EL) 1221 having a large data amount with a high quality as it is.

By doing in this manner, the scalable encoding data storage device 1202 may store the image with a high image quality only if necessary. Therefore, it is possible to suppress an increase in data amount while suppressing a decrease in value of the image due to a deterioration in image quality, and it is possible to improve a utilization efficiency of a storage area.

For example, the imaging apparatus 1201 is a surveillance camera. In the case where a surveillance target (for example, an intruder) does not appear on the captured image (in case of a normal period), since the possibility that the content of the captured image is not important is high, decreasing of the data amount is given priority, and the image data (scalable encoding data) are stored with a low quality. On the contrary, in the case where the surveillance target appears as the object 1211 on the captured image (in case of an attention period), since the possibility that the content of the captured image is important is high, the image quality is given priority, and the image data (scalable encoding data) are stored with a high quality.

In addition, the determination as to whether the situation is in a normal period or an attention period may be performed, for example, by the scalable encoding data storage device 1202 analyzing the image. In addition, the determination may be performed by the imaging apparatus 1201, and a result of the determination may be transmitted to the scalable encoding data storage device 1202.

In addition, the criterion of the determination as to whether the situation is in a normal period or an attention period is arbitrary, and the content of the image defined as the criterion of the determination is arbitrary. Of course, other conditions other than the content of the image may be defined as the criterion of the determination. For example, the normal and attention periods may be switched according to the magnitude, waveform, or the like of the recorded audio; the normal and attention periods may be switched every predetermined time; or the normal and attention periods may be switched according to external instruction such as user instruction.

In addition, heretofore, although the example where the two states of the normal period and the attention period are switched is described, the number of states is arbitrary. Three or more states of, for example, a normal period, a weak attention period, an attention period, a strong attention period, and the like may be switched. However, the upper limit of the number of switching states depends on the number of layers of the scalable encoding data.

In addition, the imaging apparatus 1201 may determine the number of layers in the scalable encoding according to the state. For example, in case of the normal period, the imaging apparatus 1201 may generate the scalable encoding data (BL) 1222 of the base layer having a small data amount with a low quality and supply the data to the scalable encoding data storage device 1202. In addition, for example, in case of the attention period, the imaging apparatus 1201 may generate the scalable encoding data (BL+EL) 1221 of the base layer having a large data amount with a high quality and supply the data to the scalable encoding data storage device 1202.

Heretofore, although the example of the surveillance camera is described, the applications of the imaging system 1200 are arbitrary and are not limited to the surveillance camera.

In addition, the LCU denotes a coding unit (CU) having the largest size, and a coding tree unit (CTU) is a unit including a coding tree block (CTB) of the LCU and a parameter at the time of the process in a LCU base (level). In addition, a CU constituting the CTU is a unit including a coding block (CB) and a parameter at the time of the process in a CU base (level).

The present invention may be applied to apparatuses used for transmitting/receiving image information (bit stream) compressed by orthogonal transform such as discrete cosine transform and motion compensation through a network medium such as satellite broadcasting, cable TV, the Internet, or mobile phones or apparatuses used for performing processes on a storage medium such as an optical disk, a magnetic disk, or a flash memory like MPEG, H.26x, or the like.

In addition, the encoding scheme according to the present invention may be an encoding scheme other than the HEVC scheme.

In addition, embodiments of the present technique are not limited to the above-described embodiments, but various modifications are available within the scope without departing from the spirit of the present technique.

In addition, the present technique may also have the configuration described hereinafter.

(1) An image processing apparatus including:

a predicted image generation unit which generates a predicted image of an image by using a reference image; and

a storage unit which preferentially stores the reference image of which display order is close to that of the image.

(2) The image processing apparatus according to (1) above, wherein in the case where the image is a moving image, the storage unit preferentially stores the reference image of which display order is close to the image, and in the case where the image is a still image, the storage unit preferentially stores the reference image of which quantization parameter is small.

(3) The image processing apparatus according to (2) above, wherein in the case where the image is a still image, the storage unit preferentially stores an I picture as the reference image.

(4) The image processing apparatus according to any of (1) to (3) above, wherein the number of reference images storable in the storage unit is determined based on a size of the image.

(5) An image processing method using an image processing apparatus, the method including:

a predicted image generating step of generating a predicted image of an image by using a reference image; and

a storing step of preferentially storing the reference image of which display order is close to that of the image.

### REFERENCE SIGNS LIST

11 Encoding device
44 Frame memory
47 Motion prediction/compensation unit
113 Decoding device
141 Frame memory
144 Motion compensation unit

1. An image processing apparatus comprising:
a predicted image generation unit which generates a predicted image of an image by using a reference image; and
a storage unit which preferentially stores the reference image of which display order is close to that of the image.

2. The image processing apparatus according to claim 1, wherein in the case where the image is a moving image, the storage unit preferentially stores the reference image of which display order is close to the image, and in the case where the image is a still image, the storage unit preferentially stores the reference image of which quantization parameter is small.

3. The image processing apparatus according to claim 2, wherein in the case where the image is a still image, the storage unit preferentially stores an I picture as the reference image.

4. The image processing apparatus according to claim 1, wherein the number of reference images storable in the storage unit is determined based on a size of the image.

5. An image processing method using an image processing apparatus, the method comprising:
a predicted image generating step of generating a predicted image of an image by using a reference image; and
a storing step of preferentially storing the reference image of which display order is close to that of the image.
